(19) United States
(12) Patent Application Publication
(10) Pub. No.: US 2017/0140403 A1
(43) Pub. Date: May 18, 2017

(54) CUSTOMER ANALYSIS SYSTEM

(71) Applicant: HITACHI, LTD., Tokyo (JP)

(72) Inventors: Marina FUJITA, Tokyo (JP); Mayuko MINOBE, Tokyo (JP); Toshiko AIZONO, Tokyo (JP); Masaki YOTSUTANI, Tokyo (JP); Koji ARA, Tokyo (JP)

(21) Appl. No.: 15/325,516

(22) PCT Filed: Jul. 30, 2015
(86) PCT No.: PCT/JP2015/071587

§ 371 Date: Jan. 11, 2017

(30) Foreign Application Priority Data
Jan. 7, 2015 (JP) 2015-001540

(51) Int. Cl. G06Q 30/02

(52) U.S. Cl. CPC G06Q 30/0204

(57) ABSTRACT

The present invention aims at providing a technique of helping to quantitatively evaluate a purchasing preference of customers, and design the purchasing preference high in the degree of matching with an actual merchandise purchasing history. The customer analysis system according to the present invention calculates the degree of matching indicative of how much a purchasing preference type of the customer matches a merchandise group in a correspondence relationship on the basis of a merchandise purchasing history of the customer, and evaluates the purchasing preference type on the basis of the calculation result (refer to FIG. 3).

### TECHNICAL FIELD

The present invention relates to a technique for analyzing a purchasing preference type of customers for merchandise.

### BACKGROUND ART

In recent years, attention is paid to a technique for analyzing a purchasing preference type of customers in a retail industry. Specifically, a purchasing trend of the customers is analyzed on the basis of a purchasing history of the customers (for example, an access history in the case of purchasing on the Web), and a merchandise matching the preference of individual customers is recommended, or an analysis result of the customer purchasing preference for each store is leveraged in store merchandising.

As a data analysis technique for extracting the merchandise matching the preference of each individual when recommending the merchandise, a collaborative filtering technique disclosed in the following Nonpatent Literature 1 has been widely used. The collaborative filtering is directed to a technique for extracting the merchandise that has been purchased by another customer similar in the purchasing trend to a subject customer but has not been purchased by the subject customer.

The following Patent Literature 1 discloses a technique in which information indicating the content of each merchandise is allocated to the merchandise as a merchandise product attribute, and the merchandise linked with the attribute likely to be purchased is recommended. The literature has proposed a technique in which, for the purpose of providing highly effective information compatible with a user, the merchandise attribute allocated to the merchandise is linked with a type of the customers who purchase the attribute to increase information on both of the customers and the merchandises. More specifically, the merchandise strongly linked with the type to which the individual belongs is extracted as the merchandise matching the preference of the individual, and type information on each customer is presented as a reason to purchase that merchandise.

The following Patent Literature 2 discloses a technique for analyzing purchase psychological factors such as purchasing motivations and intentions of consumers or customers for the purpose of helping to consider a merchandise planning or a service to be provided. In the literature, the customers' purchase psychological factors are quantitatively analyzed by the quantitative analysis of questionnaire although the purchasing history is not used. As a result, it is conceivable to help to grasp the purchasing trend of the customers, and extract a potential customer segment.

### CITATION LIST

### Patent Literature

Patent Literature 1: Japanese Unexamined Patent Application Publication No. 2012-234503

Patent Literature 2: Japanese Unexamined Patent Application Publication No. 2008-299684

### Nonpatent Literature

Nonpatent Literature 1: Amazon.com Recommendations: Item-to-Item Collaborative Filtering”, Greg Linden, Brent Smith, Jeremy York, Journal IEEE Internet Computing 7, 1, pp. 76-80, 2003.

### SUMMARY OF INVENTION

### Technical Problem

For example, in order to implement such as store merchandising, new merchandise development, or a message created with appeal at the time of recommendation, there is a need to understand not only the merchandise likely to be purchased by the customer, but also why the customer purchases the merchandise, i.e. it is necessary to understand where customers' needs exist. Therefore, in order to provide the merchandise and service which are the customer's needs in the retail industry, the following two requirements are demanded.

(Requirement 1) A merchandise group corresponding to (likely to be merchandised by) the individual or the customer segment is extracted with high precision.
(Requirement 2) A psychological factor of the purchase (reason to purchase) which stays in the background of an extracted correspondence relationship of the customers and the merchandise group can be interpreted by a business person in charge.

In Patent Literature 1, the merchandise extraction demanded in Requirement 1 can be performed, but the merchandise reason demanded in Requirement 2 is difficult to presume. On the contrary, Patent Literature 2 can not only recommend the merchandise but also provide the recommendation reason corresponding to a type of each customer. The type of the customer includes: customer information allocated from information on sex and age other than the merchandise; and information indicative of a purchasing preference such as an upmarket. The psychological factor of the purchase such as the purchasing motivation and intention of the customer can be grasped from the type (purchasing preference type) related to the preference as described in the latter. With the use of the purchasing preference type, not only the effective information to promote the purchase depending on the individual in the merchandise recommendation can be provided, but also the purchasing preference type can be effectively leveraged even in a merchandising business such as needs grasp for new merchandises and an appropriate assortment in a store.

Before the preference type of each customer is estimated, it is necessary to extract the merchandise feature in advance, allocate the merchandise feature as the merchandise attribute, and define the purchasing preference type of the customer corresponding to the merchandise attribute. The purchasing preference type of each customer is estimated by analyzing the merchandising history of the customer according to the definition of the purchasing preference type. As a result, the purchasing reason staying in the background of the purchasing history can be estimated.

Up to now, the purchasing preference type has been designed through a trial-and-error process by allowing the business person in charge to repeat the try and error. However, because such a process depends on the experience and intuition of the business person in charge, a working man-hour is long, and no transparency is guaranteed. In addition, when the purchasing preference type of the consumer and a linkage between the purchasing preference type and the merchandise attribute are changed in association with a temporal change in a social climate and personal values, the business person in charge is required to redesign the purchasing preference type. Therefore, it is not desirable to design the purchasing preference type through the technique depending on the experience and the intuition of the business person in charge.

On the other hand, a task of designing the purchasing preference type can be regarded as a task of deviating the merchandise feature corresponding to the customer segment from the viewpoint of the psychological factor of the purchase in the marketing. Therefore, it is conceivable that the purchasing preference type can be designed through a quantitative marketing analysis technique not depending on the intuition and the experience disclosed in Patent Literature 2. However, such a technique causes a problem that a labor of the questionnaire per se is heavy. Also, because it is difficult to continuously implement the questionnaire, it is difficult to follow the temporal change.

As described above, in order to extract the merchandise group corresponding to the individual or customer segment with high precision without excessively impairing the interpretation of the psychological factor of the purchasing, it is effective to design abstractions related to the psychological factor of the purchasing such as the merchandise attribute and the purchasing preference type, and a correspondence relationship between those respective abstractions in advance. However, the conventional manual design and the conventional design using the questionnaires are limited, and a purchasing preference type design technique capable of continuously updating the design without depending on the experience and the intuition is demanded.

The present invention has been made in view of the above problems, and it is an object of the present invention to provide a technique of helping to quantitatively evaluate a purchasing preference of customers, and design the purchasing preference high in the degree of matching with an actual merchandise purchasing history.

### Solution to Problem

The customer analysis system according to the present invention calculates the degree of matching indicative of how much a purchasing preference type of a customer matches a merchandise group in a correspondence relationship on the basis of a merchandise purchasing history of the customer, and evaluates the purchasing preference type on the basis of the calculation result.

### Advantageous Effects of Invention

The customer analysis system according to the present invention can design the purchasing preference type that matches the merchandise purchasing history of the customer with high precision.

### BRIEF DESCRIPTION OF DRAWINGS

FIG. 1 is a diagram illustrating a design of a purchasing preference type.

FIG. 2 is a graph illustrating a state in which a customer analysis system updates a preference type graph.

FIG. 3 is a functional block diagram of a customer analysis device 300 according to a first embodiment.

FIG. 4 is a diagram illustrating a configuration of relationship matrix data 311.

FIG. 5 is a flowchart illustrating a process of evaluating and updating the preference type graph by an evaluator 330.

FIG. 6 is a flowchart illustrating details of Step S501.

FIG. 7 is a flowchart illustrating details of Step S603.

FIG. 8 is a diagram illustrating an example of a merchandise matching degree vector 341.

FIG. 9 is a flowchart illustrating details of Step S605.

FIG. 10A is a table illustrating an element value (update indication flag) of update indication matrix data 335.

FIG. 10B is a diagram illustrating a configuration of update instruction matrix data 335.

FIG. 11 is a flowchart illustrating details of Step S608.

FIG. 12 is a diagram illustrating a configuration example of update history data 352.

FIG. 13 is a flowchart illustrating details of Step S502.

FIG. 14 is a flowchart illustrating details of Step S1302.

FIG. 15 is a flowchart illustrating details of Step S1304.

FIG. 16 is a flowchart illustrating details of Step S503.

FIG. 17 is a flowchart illustrating details of Step S1602.

FIG. 18 is a flowchart illustrating details of Step S1603.

FIG. 19 is a flowchart illustrating details of Step S1606.

FIG. 20 is a flowchart illustrating details of Step S504.

FIG. 21 is a flowchart illustrating a process of creating a post-update feature list 383 by an updater 370.

FIG. 22 is a diagram illustrating an example of the post-update feature list 383.

FIG. 23 is a screen configuration example of a matching degree setting screen 2300 provided by a display 360.

FIG. 24 is a diagram illustrating a screen configuration example of a division setting screen 2400 provided by the display 360.

FIG. 25 is a diagram illustrating a screen configuration example of an integration setting screen 2500 provided by the display 360.

FIG. 26 is a diagram illustrating a screen configuration example of an update result screen 2600 on which the display 360 displays an update result of a preference type based on a post-update feature list 383.

FIG. 27 is a diagram illustrating a screen configuration example of a time series screen 2700 provided by the display 360.

FIG. 28 is a configuration diagram of a customer analysis system 1000 according to a second embodiment.

FIG. 29 is a diagram illustrating an example of a recommendation matrix 2900 describing merchandise recommended measures determined on the basis of an analysis result by a customer analysis device 300.

FIG. 30 is a diagram illustrating a screen configuration example of a recommendation reaction analysis screen 3000 used when a business person in charge analyzes a reaction of the customer to the merchandise recommended measures based on an analysis result by the customer analysis device 300.

FIG. 31 is a diagram illustrating a screen configuration example of a display consideration screen 3100 used when the business person in charge analyzes a type and an on-the-shelf placement of display merchandises in a store based on an analysis result by the customer analysis device 300.

### DESCRIPTION OF EMBODIMENTS

### First Embodiment: Concept Description

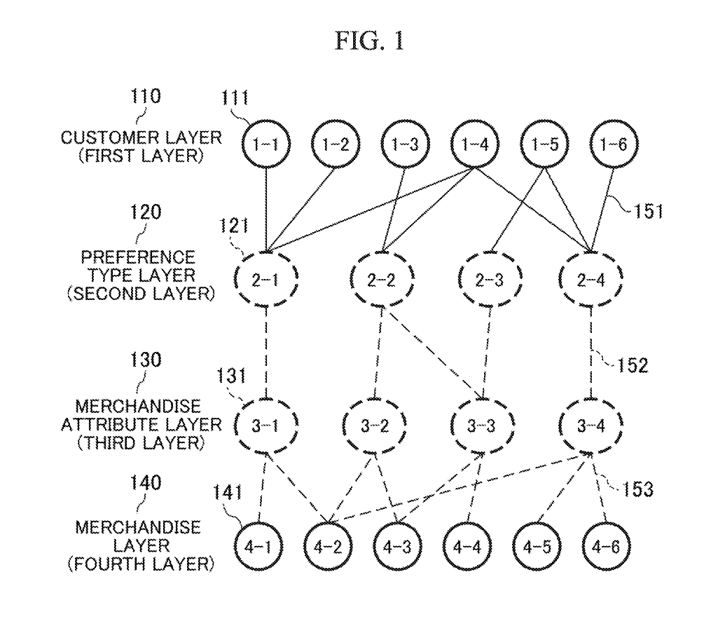

FIG. 1 is a diagram illustrating a design of a purchasing preference type. The purchasing preference type can be expressed by a graph structure having a hierarchy illustrated in FIG. 1 (preference type graph). Hereinafter, the respective nodes and the respective paths of a graph illustrated in FIG. 1 will be described.

A customer layer 110 is a layer having customer nodes 111 corresponding to the respective customers. A preference type layer 120 is one layer below the customer layer 110, which represents a purchasing preference type of each customer. Preference type nodes 121 are nodes in the preference type layer 120, and correspond to the respective purchasing preference types. Each purchasing preference type means a merchandise purchasing trend of the customer which can be estimated from the merchandises purchased by the customer. For example, the purchasing preference types include a “health trend type” that means a purchasing trend for preferably purchasing a health food, a “fond of sale type” that means a trend for being likely to purchase only discount merchandises, and a “fond of new merchandise type” that means a trend for frequently merchandising merchandises just released. Paths 151 are paths that represent a correspondence relationship between the customer nodes 111 and the preference type nodes 121. The preference types of the respective customers are associated with the customers by the paths 151. One customer may be linked to the multiple preference types such as “fond of new merchandise type” and “health trend type”, and a customer may be linked to none of the preference types.

A merchandise attribute layer 130 is a layer corresponding to the attributes of the merchandises, and has merchandise attribute nodes 131. The merchandise attribute means a feature of the merchandise which may cause the customer's purchase activity to be promoted or inhibited. For example, the feature includes “calorie off”, “low cost”, “discount”, and “new merchandise”. Paths 152 are paths between the preference type nodes 121 and the merchandise attribute nodes 131 and mean a correspondence relationship between the respective merchandise attributes and the preference types. For example, when there is a positive linkage between the merchandise attribute “calorie off” and the preference type “health trend type”, the customer belonging to the health trend type is likely to purchase the calorie-off merchandise. Likewise, a negative linkage can also be defined. For example, when the merchandise attribute “carcinogen” and the preference type “health trend type” are negatively linked to each other, such a linkage means that the customer belonging to the health trend type is unlikely to purchase the merchandise having a carcinogen. One merchandise attribute node 131 may be linked to the multiple preference type nodes 121, and the multiple merchandise attribute nodes 131 may be linked to one preference type node 121. For example, when the merchandise attributes “calorie off” and “dietary fiber” are positively linked to the health trend type, such a case is interpreted as “the health trend type is likely to purchase the merchandise associated with the calorie off or the dietary fiber (OR relationship)”, or “the health trend type is likely to purchase the merchandise associated with the calorie off and the dietary fiber (AND relationship)”. The difference of those interpretations will be described later.

A merchandise layer 140 is a layer corresponding to the merchandises and has merchandise nodes 141. Paths 153 are paths between the merchandise attribute nodes 131 and the merchandise nodes 141, and means a correspondence relationship between the merchandise nodes 141 and the merchandise attribute nodes 131. When the path 153 is provided to the merchandise, the merchandise has a property of the associated merchandise attribute node 131. One merchandise node 141 may be linked to the multiple merchandise attribute nodes 131, and the merchandise nodes 141 may be linked to none of the merchandise attribute nodes 131.

The customer nodes 111 and the merchandise nodes 141 are nodes in which there is an entity, and the preference type nodes 121 and the merchandise attribute nodes 131 are nodes representing an abstraction for interpreting a psychological factor of the purchase. The preference type layer 120 is a layer for describing the customer, and the merchandise attribute layer 130 are layers for describing the merchandises. The layer for describing the merchandise can be configured by multiple hierarchies. For example, the layer for describing the merchandise may be hierarchized into two layers as a merchandise attribute (coarse classification) and a merchandise attribute (fine classification). The preference type layer 120 may conceptually have a hierarchical structure on the assumption that a geriatric prevention type, a diet type, a skin care type, and so on are present below the health trend type, for example. However, the hierarchy is not set on the preference type graph used in evaluating the design of the preference type.

In the correspondence relationship between the layers for describing the merchandise, the layers are linked to each other by a positive path or no path is present. Even when the multiple paths are linked to the merchandise attribute nodes 131 from a lower layer, only any one of those paths is effective.

The correspondence relationships between the layer for describing the consumer and the layer for describing the merchandise include three types, i.e. a positive path, a negative path, and no linkage. Multiple paths may extend to a certain node from the lower layer. The relationship between the multiple paths toward a same node may be an AND relationship or an OR relationship. Whether the relationship is the AND relationship or the OR relationship is defined on the preference type graph.

It is assumed that a path on the preference type graph occurs only between the two layers, and does not go across the layer. When the correspondence relationship that the path goes across the layer is present in designing the preference type, a dummy node is added to the concept layer as a path between the two layers. For example, it is assumed that: there are two layers for describing the merchandise; a merchandise coarse classification node and a new-merchandise node are present in a first layer; a merchandise fine classification node is present in a second layer below the first layer. Because the new-merchandise node in the first layer is included in the merchandise coarse classification node, there is a possibility that there is no merchandise fine classification node linked to the new-merchandise node. In that case, the dummy node having the correspondence relationship with the new-merchandise node is created in the second layer, thereby being capable of linking a layer below the second layer to the new-merchandise node.

To design the purchasing preference type is to define the preference type nodes 121, the merchandise attribute nodes 131, and the merchandise nodes 141, and also to define the paths 151 to 153 between those nodes. The business person in charge designs the other nodes and paths on the assumption of the preference type nodes 121 provisionally designed, at the time of first designing those nodes.

The customer analysis system according to the present invention estimates a purchasing preference type that represents an actual merchandise purchasing history with high precision with the use of the merchandise purchasing history of the customer. For example, the customer analysis system extracts a group of the merchandise nodes 141 purchased by a certain customer and the associated purchasing preference type in the actual merchandise purchasing history on the basis of a graph structure designed by the business person in charge, thereby estimating the path 151 between the customer nodes 111 and the preference type node 121. The node used in estimating the purchasing preference type is associated with the merchandise purchasing history, and is not limited to the merchandise nodes 141. For example, the merchandise purchasing history uses a node indicative of a purchasing time instead of the merchandise nodes 141, and the purchasing preference type associated with the purchasing time may be defined such as “midnight purchasing type” as the purchasing preference type.

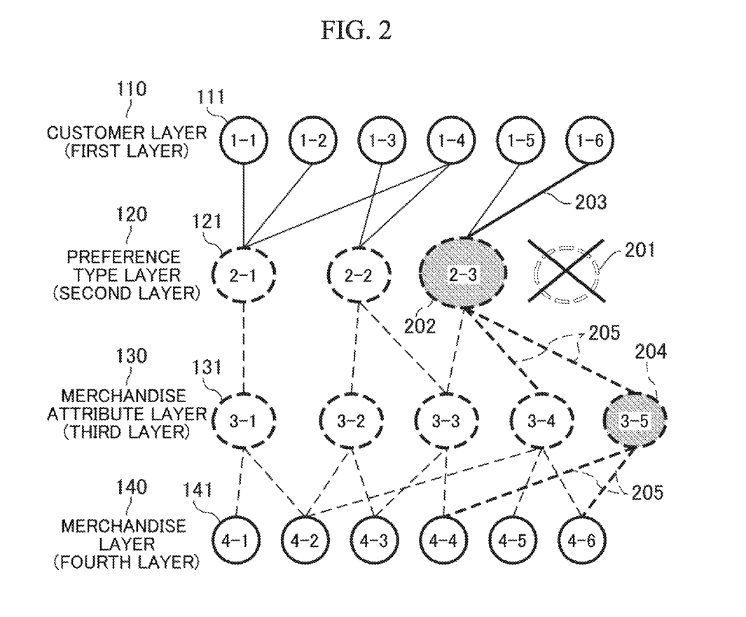

FIG. 2 is a graph illustrating a state in which the customer analysis system according to the present invention updates a preference type graph. The customer analysis system according to the present invention helps to update the nodes and the paths of the preference type graph so as to obtain the preference type graph closer to the actual merchandise purchasing history than the preference type graph firstly designed by the business person in charge.

A node 201 is an example of the node deleted by the customer analysis system. When it is determined that the preference type designed by the business person in charge does not appropriately express the customer segment for purchasing the target merchandise group linked to the preference type, the preference type can be deleted. With the deletion of the node 201, the path linked to the node is also deleted. A node 202 is a preference type in which the number of paths from the merchandise attribute layer 130 is increased more than that before update. Paths 205 are paths added to the node 202. A node 204 is a merchandise attribute node newly added according to a change in the preference type graph. A path 203 is a path changed between the customer layer 110 and the preference type layer 120 according to a change in the preference type graph.

As illustrated in FIG. 2, the customer analysis system according to the present invention can extract an update draft of the preference type graph structure so as to approach the preference type graph that more accurately expresses the actual merchandise purchasing history. In more detail, the customer analysis system proposes a division, deletion, addition, and integration of the node, and an addition, deletion, and change of the path between the layers (a change in the type of the positive path and the negative path). A method of evaluating the preference type graph and a method of specifying a change portion will be described later.

### First Embodiment: System Configuration

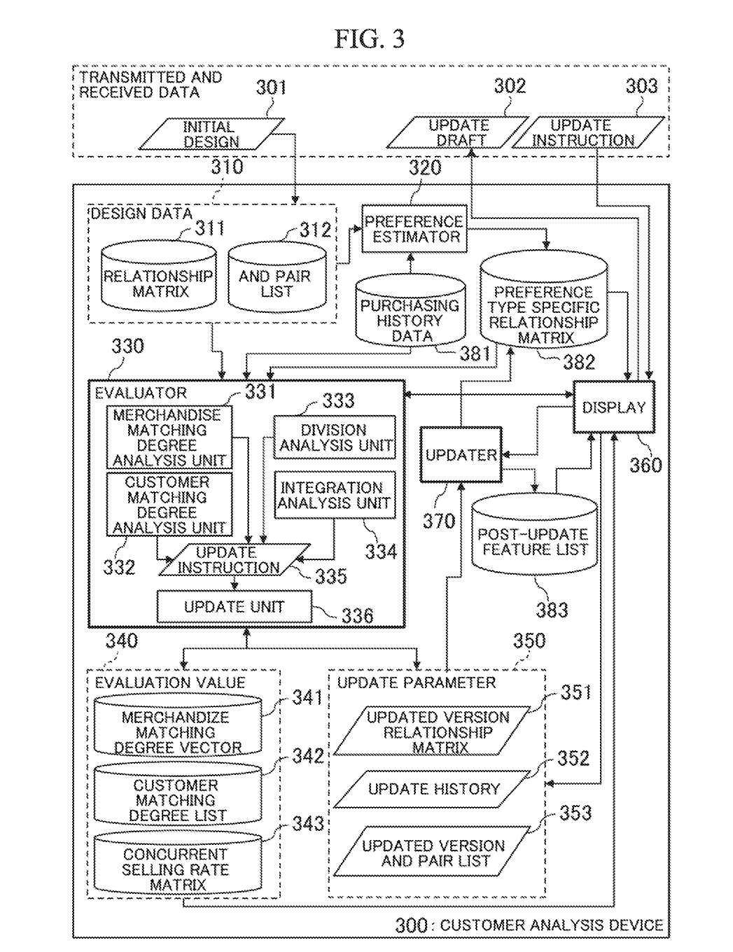

FIG. 3 is a functional block diagram of a customer analysis device 300 according to a first embodiment of the present invention. The customer analysis device 300 sets the preference type graph initially designed with the use of the preference type high in the interpretation designed by the business person in charge as an initial input, and evaluates the degree of matching between the merchandise group linked to each preference type in the actual merchandise purchasing history and the merchandise group linked on the preference type graph initially designed. The customer analysis device 300 provides a draft for changing the preference type graph so as to improve the degree of matching, thereby helping to design a more effective preference type while avoiding impairing the interpretation as much as possible. Hereinafter, a functional block of the customer analysis device 300 illustrated in FIG. 3 will be described.

The customer analysis device 300 receives initial design data 301 and update instruction data 303, and outputs update draft data 302. The initial design data 301 is data describing the preference type graph initially designed by the business person in charge and the preference type graph illustrated in FIGS. 1 and 2. The update draft data 302 is data describing a draft for updating the preference type graph so as to reflect the actual merchandise purchasing history more on the basis of a result of evaluating the initial design data 301 by the customer analysis device 300. The update instruction data 303 is data for instructing a final update result of the preference type graph to the customer analysis device 300 by the business person in charge.

The initial design data 301 is data describing initial design values of each node and each path of a solid-line type graph illustrated in FIG. 1. The business person in charge designs the initial design data 301 as an input to the customer analysis device 300. The business person in charge may not enter all of the initial design data 301. For example, the business person in charge may design the correspondence relationship between the merchandise attribute and the correspondence relationship between the merchandise attribute and the merchandise with the use of the merchandise data included in the merchandise master which is present in advance. In addition, the number of layers of the preference type graph to be designed may be increased, and a keyword layer may be set below the merchandise attribute layer 130 to automatically estimate the correspondence relationship between the merchandise and the merchandise attribute. As the automatic estimation method, it is conceivable that a feature key word is extracted from a merchandise name and a merchandise description with the use of text mining, and the merchandise having the merchandise attribute and the corresponding keyword is associated with the merchandise attribute. The customer analysis device 300 receives the initial design data 301 through an appropriate interface, converts the initial design data 301 into an appropriate format, and then stores the initial design data 301 thus converted as design data 310. The details of the design data 310 will be described later.

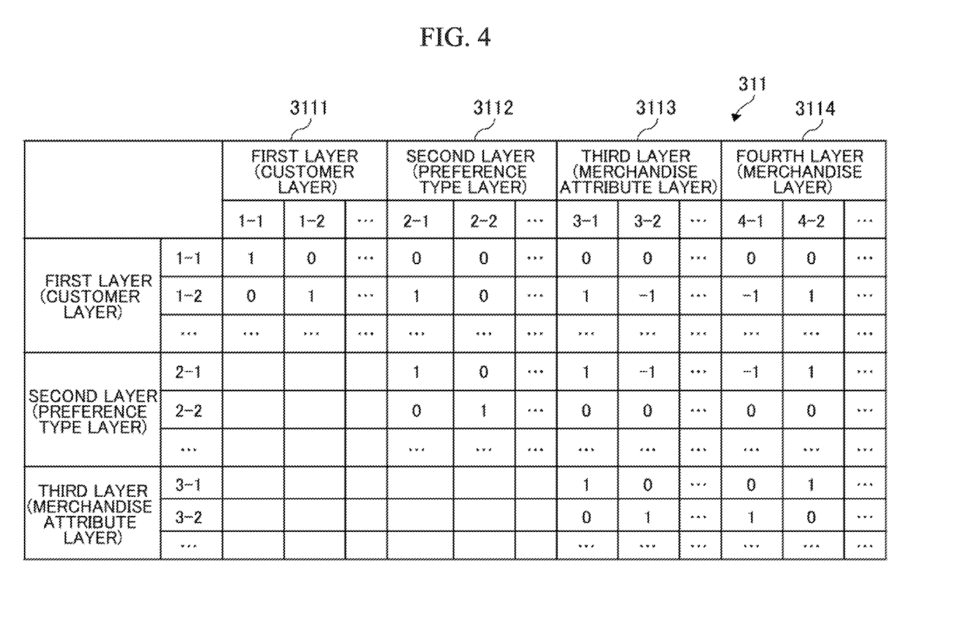

The design data 310 is data describing the preference type graph in a format easily processed by the customer analysis device 300. Relationship matrix data 311 describes the respective nodes and the connection relationships between the respective nodes on the preference type graph. The details of the relationship matrix data 311 will be described with reference to FIG. 4. An AND pair list 312 is data describing whether the multiple paths are in an OR relationship or an AND relationship when the multiple paths are associated with the same node. For example, the AND pair list 312 describes an ID of the preference type node 121 having multiple paths associated by the AND relationship and an ID of the merchandise attribute node 131 linked to the preference type node 121.

A preference type estimator 320 receives the design data 310 and purchasing history data 381 and outputs preference type specific relationship data 382. The purchasing history data 381 is data describing purchase histories of merchandises by each individual. The preference type specific relationship data 382 is data describing whether or not each customer belongs to each preference type node 121 and each node located below the preference type node 121.

The preference type estimator 320 estimates to which purchasing preference type each individual belongs, and describes the estimation result in the preference type specific relationship data 382. Specifically, the preference type estimator 320 calculates the number of purchases (or purchasing rate) of the merchandise linked to each merchandise attribute node 131 and each preference type node 121 from the merchandises purchased by the individual. If the calculated number of merchandises exceeds a reference value, the preference type estimator 320 associates the customer nodes 111 with the preference type nodes 121 using a positive path. If the calculated number of merchandises falls below the reference value, the preference type estimator 320 associates the customer nodes 111 with the preference type nodes 121 using a negative path. The reference value may be determined by the business person in charge in advance, or may be calculated taking an overall average or a standard deviation into consideration.

The result of estimating the customer nodes 111 belonging to each preference type node 121 by the preference type estimator 320 is used when an evaluator 330 calculates a customer matching degree list 342 to be described later. Further, a display 360 and an updater 370 are used to calculate estimated values of the number of customers and the number of merchandises belonging to each preference type when the preference type graph is changed. A method of estimating the number of customers and the number of merchandises after the preference type graph has been changed is the same as when the preference type is evaluated. The number of customers and the number of merchandises can be estimated on the basis of only the correspondence relationship between the target node and the preference type without taking a layer above the subject layer into consideration. For example, the analysis is not implemented on all of the layers described by the preference type specific relationship data 382, but only the preference type layer 120 and the merchandise attribute layer 130 may be estimated.

The evaluator 330 evaluates how much the correspondence relationship between the customer segment and the merchandise group derived from the preference type graph described by the initial design data 301 match the correspondence relationship estimated from the purchasing history data 381. The evaluator 330 outputs an update (path change/node division/node integration, or the like) draft of the preference type graph that more approaches the actual correspondence relationship estimated from the purchasing history data 381 on the basis of the evaluation result. The evaluator 330 receives the design data 310, the preference type specific relationship data 382, and the purchasing history data 381, and outputs an evaluation value 340, update version relationship matrix data 351, and update history data 352. When the preference type graph is to be further updated after outputting the update version relationship matrix data 351 and the update history data 352, the updater 370 may implement the processing with the use of only the final update result or may implement the processing every time the update version relationship matrix data 351 and the update history data 352 are updated.

The evaluator 330 includes a merchandise matching degree analysis unit 331, a customer matching degree analysis unit 332, a division analysis unit 333, an integration analysis unit 334, an update instruction matrix data 335, and an update unit 336.

The merchandise matching degree analysis unit 331 outputs a merchandise matching degree vector 341. The customer matching degree analysis unit 332 outputs the customer matching degree list 342. The division analysis unit 333 outputs a concurrent selling rate matrix 343. The specific calculation method will be described later. The integration analysis unit 334 receives the merchandise matching degree vector 341. The division analysis unit 333 receives the concurrent selling rate matrix 343. The merchandise matching degree analysis unit 331, the customer matching degree analysis unit 332, the division analysis unit 333, and the integration analysis unit 334 outputs the update instruction matrix data 335 as an update draft of the preference type graph on the basis of the evaluation value 340.

The update unit 336 receives the update instruction matrix data 335 outputted by the merchandise matching degree analysis unit 331, the customer matching degree analysis unit 332, the division analysis unit 333, and the integration analysis unit 334, and outputs the update version relationship matrix data 351 describing the update draft of the preference type graph and the update history data 352 describing the update history. When updating the preference type graph, the update unit 336 makes consideration so that a change in one portion of the graph avoids as much influence on the other portion of the graph as possible. The specific technique will be described later.

The display 360 instructs the evaluator 330 to analyze the preference type graph. Also, the display 360 presents the evaluation result caused by the evaluator 330 to the business person in charge. Further, the display 360 presents the evaluation result caused by the evaluator 330 to the business person in charge. Further, the display 360 receives an update instruction (update instruction data 303) from the business person in charge and instructs the evaluator 330 to update the preference type graph. The display 360 receives the update instruction related to the AND relationship and the OR relationship between the multiple paths on the preference type graph from the business person in charge, and outputs the update instruction as an update version AND pair list 353.

The display 360 interactively presents a function for designing the purchasing preference type. Specifically, the display 360 (a) presents an update draft of the preference type graph, (b) presents an improvement rate of a certainty of the preference type graph after updating or a certainty before and after the updating, and (c) presents the update history to the preference type graph after updating from the preference type graph before updating. As a result, the display 360 can help the update to the probable preference type graph. In addition, the display 360 presents a feature of a portion common to a change portion of the preference type graph before and after updating to the business person in charge, as a result of which the business person in charge helps to interpret the preference type after updating.

The updater 370 receives update parameter 350, updates the preference type graph, and overwrites and stores the update result in the preference type specific relationship data 382. In addition, the updater 370 extracts a feature change in the preference type between before and after updating, and outputs the extracted feature change as a post-update feature list 383. The details of the post-update feature list 383 will be described later.

FIG. 4 is a diagram illustrating a configuration of the relationship matrix data 311. The relationship matrix data 311 is described by each cell representing the correspondence relationship between the nodes. A value of each cell represents a connection relationship between the nodes. 0 represents no path, 1 represents a connection by using the positive path, and −1 represents a connection by using the negative path. Columns 3111 to 3114 represent the respective layers, and all nodes present in each column are recited as a sub-column. In a data example illustrated in FIG. 4, for example, a preference type node 2-1 and a merchandise attribute node 3-2 are linked by the negative path.

In the connection relationship between the nodes in the same layer, a connection to the subject node is represented as the positive path, and no path to the nodes other than the subject node in the same layer is present. The connection relationship between the layers apart by two or more layers is represented as the connection relationship through a middle layer. A case where no path going through the middle layer is present is set as 0, and a case where a path going through the middle layer is present is set as 1. For example, the preference type node 2-1 and the merchandise node 4-2 are connected to each other through the positive paths in the merchandise attribute layer 130 and the preference type layer 120. A same node may be connected to both of the positive path and the negative path depending on the preference type graph. In such a case, multiple values are described in the cell. Hereinafter, a cell value representative of the connection relationship between the nodes may be called “relationship flag”.

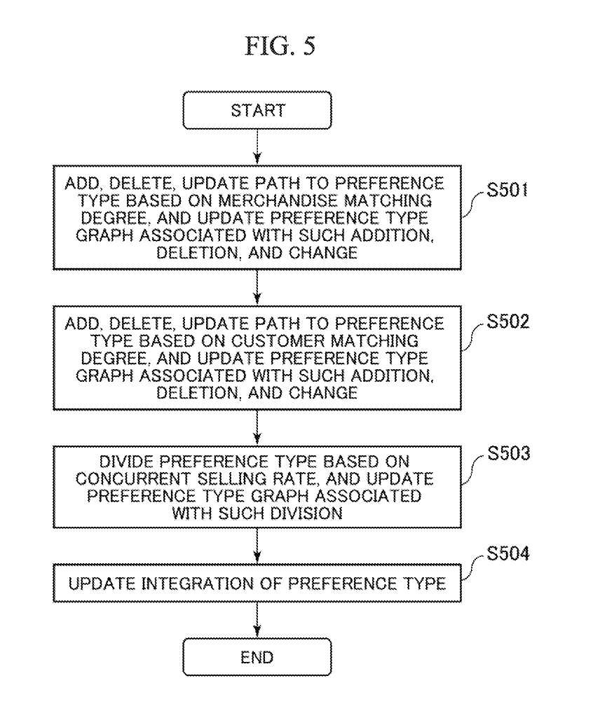

FIG. 5 is a flowchart illustrating a process for evaluating and updating the preference type graph by the evaluator 330. The evaluator 330 starts the present flowchart on the basis of the update instruction of the business person in charge, or starts the present flowchart, for example, with an appropriate trigger, and automatically updates the preference type graph. In addition, the evaluator 330 may determine whether to automatically update only some steps, or present the steps to the business person in charge according to the evaluation value. Hereinafter, the respective steps in FIG. 5 will be described.

### (FIG. 5: Steps S501 to S504: Supplemental)

Steps S501 to S504 can be performed, independently (that is, each data of the evaluation value 340 can be calculated, independently). Therefore, only a part of the evaluation value 340 may be calculated according to an instruction of the business person in charge, or a function of calculating an additional evaluation value may be added. For example, if the preference type is not divided, the concurrent selling rate matrix 343 may not be calculated. Alternatively, if only the preference type, a scale (the number of persons belonging to the preference type) of which is equal to or more than a predetermined value, is to be estimated, a function of outputting the update draft corresponding to the number of customers belonging to each preference type may be added, and preference type specific customer number data may be added to the evaluation value 340. The order and the number of those steps are not limited to those illustrated in FIG. 5.

### (FIG. 5: Step S501)

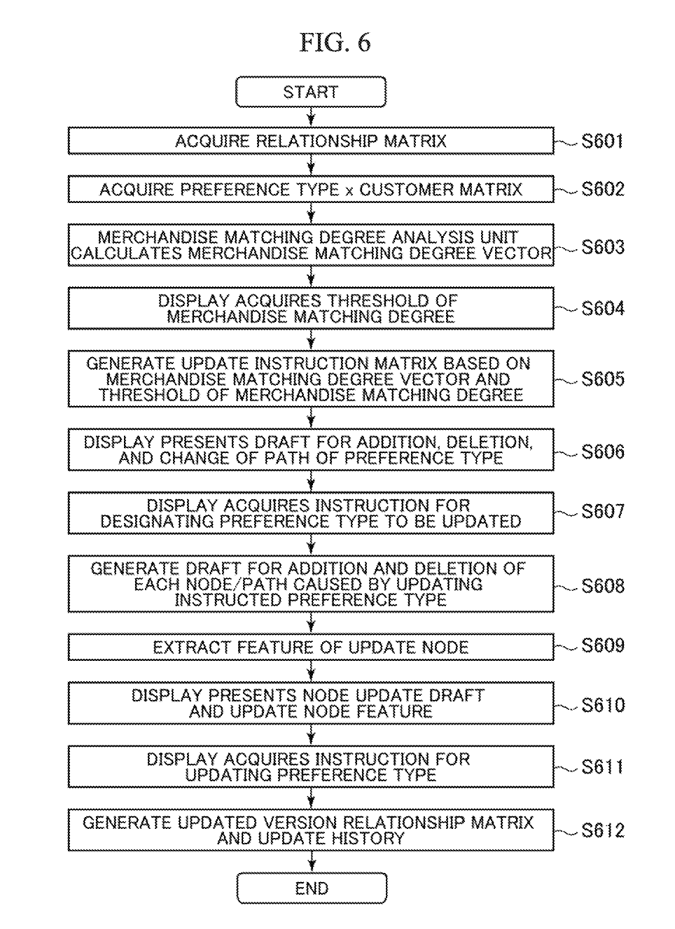

The evaluator 330 adds, deletes, and changes the path of the preference type on the basis of the merchandise matching degree, and updates the preference type graph in association with the addition, deletion, and change. The merchandise matching degree is a value indicative of how much the merchandise nodes 141 associated with the customer nodes 111 belonging to a certain preference type nodes 121 on the preference type graph matches the actual merchandise purchasing history in the purchasing history data 381. It is conceivable that the preference type graph with high level of the merchandise matching degree represents the correspondence relationship between the purchasing preference type of the customer described by the purchasing history data 381 and the merchandise with high precision. The details of the present step will be described with reference to FIG. 6.

### (FIG. 5: Step S502)

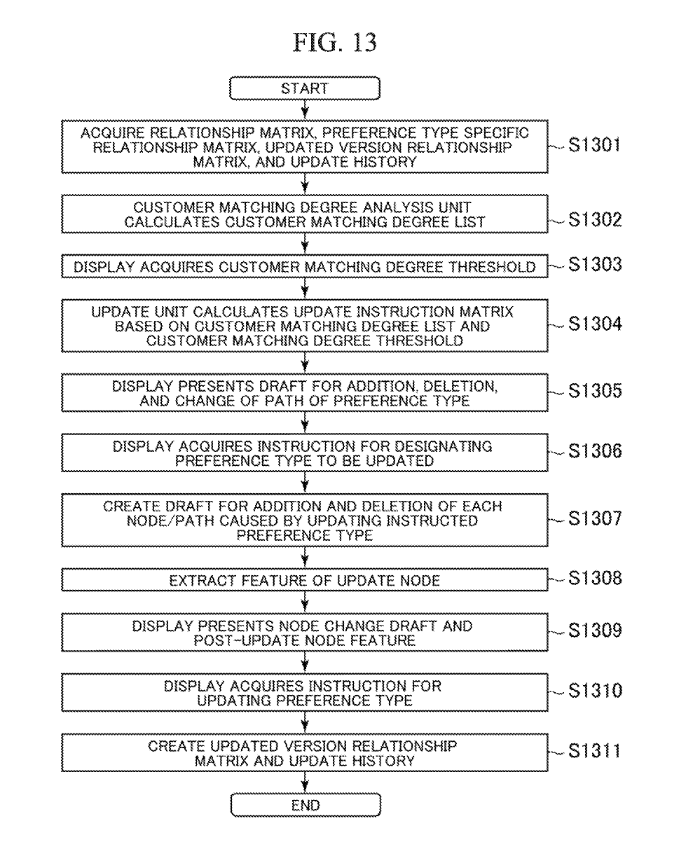

The evaluator 330 adds, deletes or changes the path of the preference type on the basis of the customer matching degree, and updates the preference type graph in association with the addition, deletion, or change. The customer matching degree is a value indicative of how much the connection relationship (for example, it is conceived that the customers belonging to the same node are connected to each other on the graph) of the customer nodes 111 on the preference type graph match the customer segment on the purchasing history data 381. The preference type graph high in the merchandise matching degree represents the customer segment suggested by the purchasing history data 381 with high precision. The details of the present step will be described with reference to FIG. 13.

### (FIG. 5: Step S503)

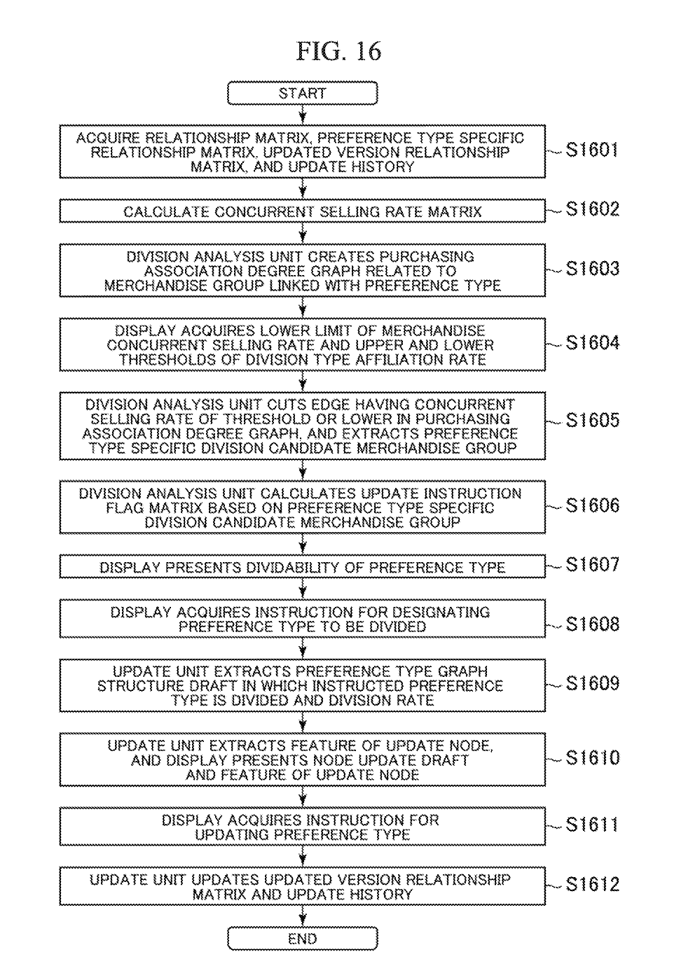

The evaluator 330 divides the preference type on the basis of the concurrent selling rate, and updates the preference type graph in association with the division. The concurrent selling rate represents, for example, a probability for a certain customer to purchase a merchandise B when purchasing a merchandise A. When the concurrent selling rate of the merchandise group belonging to a certain preference type node is low, it is conceivable that the preference type node is to be divided. The details of the present step will be described with reference to FIG. 16.

### (FIG. 5: Step S504)

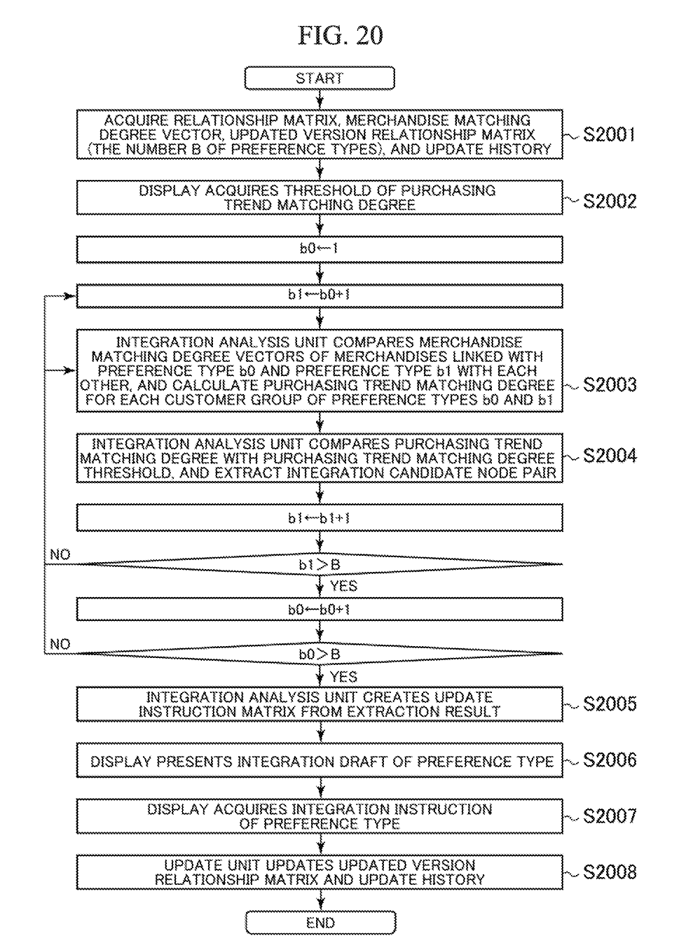

The evaluator 330 integrates the preference types together on the basis of the degree of similarity between the preference types, and updates the preference type graph in association with the integration. The degree of similarity between the preference types can be obtained, for example, by calculating a correlation function between the merchandise nodes 141 belonging to each preference type node 121 on the basis of the purchasing history data 381. The details of the present step will be described with reference to FIG. 20.

### First Embodiment: Evaluation Based on Merchandise Matching Degree

FIG. 6 is a flowchart illustrating the details of Step S501. Hereinafter, the respective steps in FIG. 6 will be described.

### (FIG. 6: Steps S601 and S602)

The evaluator 330 acquires the relationship matrix data 311 (S601). The evaluator 330 acquires a matrix (preference type×customer matrix) describing the customer belonging to each preference type from the preference type specific relationship data 382 (S602).

### (FIG. 6: Step S603)

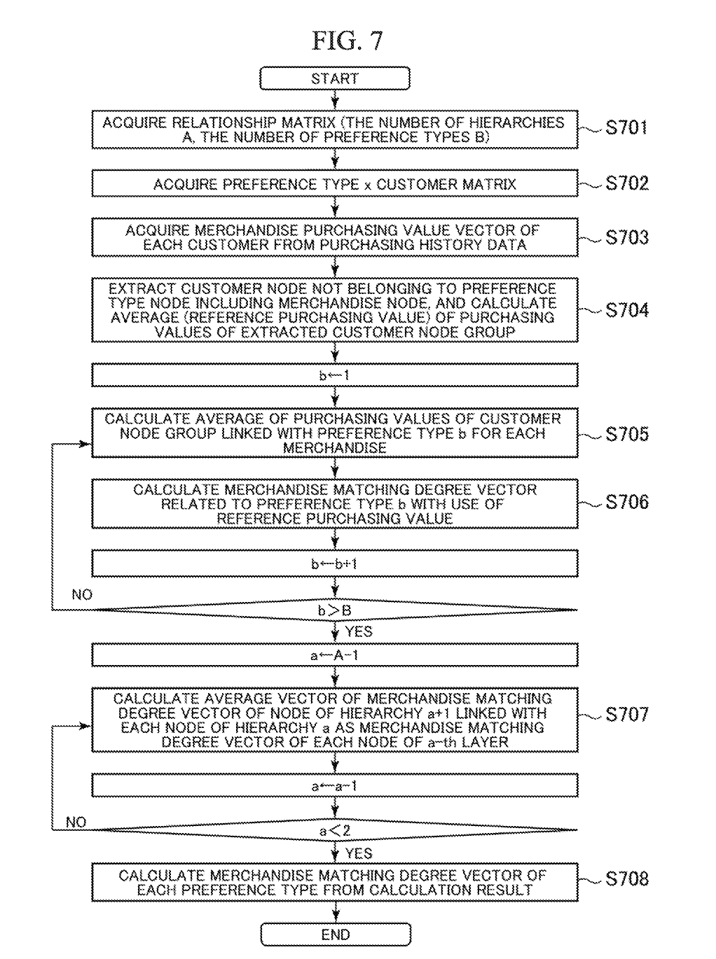

The merchandise matching degree analysis unit 331 calculates the merchandise matching degree vector 341. The details of the present step will be described with reference to FIG. 7.

### (FIG. 6: Step S604)

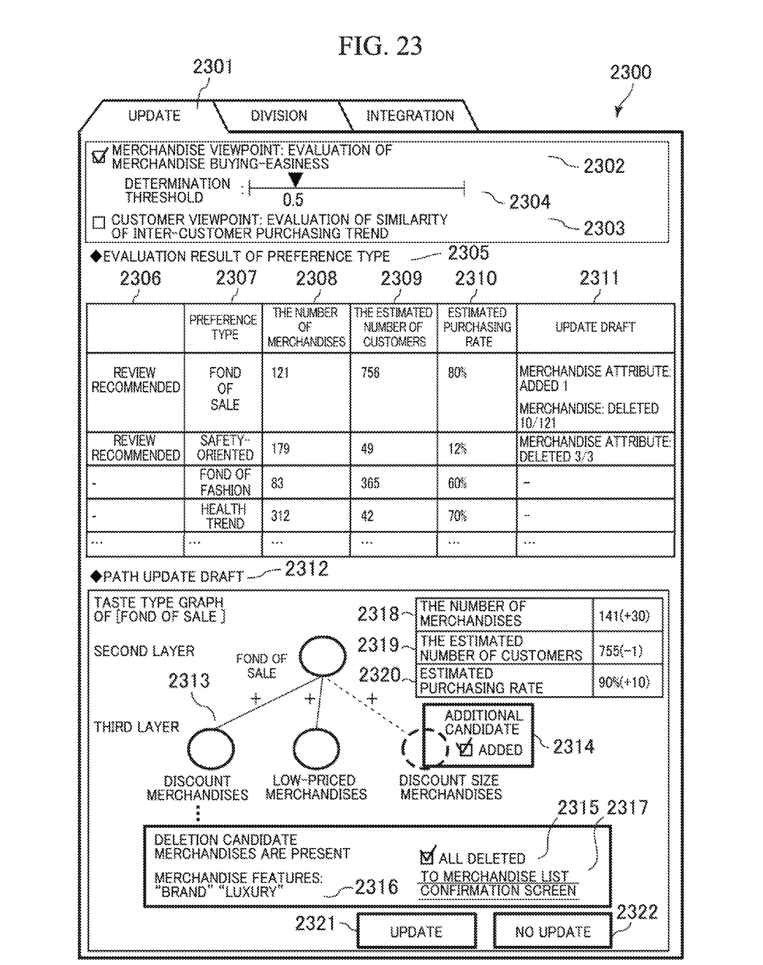

The evaluator 330 acquires a threshold of the merchandise matching degree from the display 360. A screen interface that designates the threshold of the merchandise matching degree will be described with reference to FIG. 23 to be described later.

### (FIG. 6: Step S605)

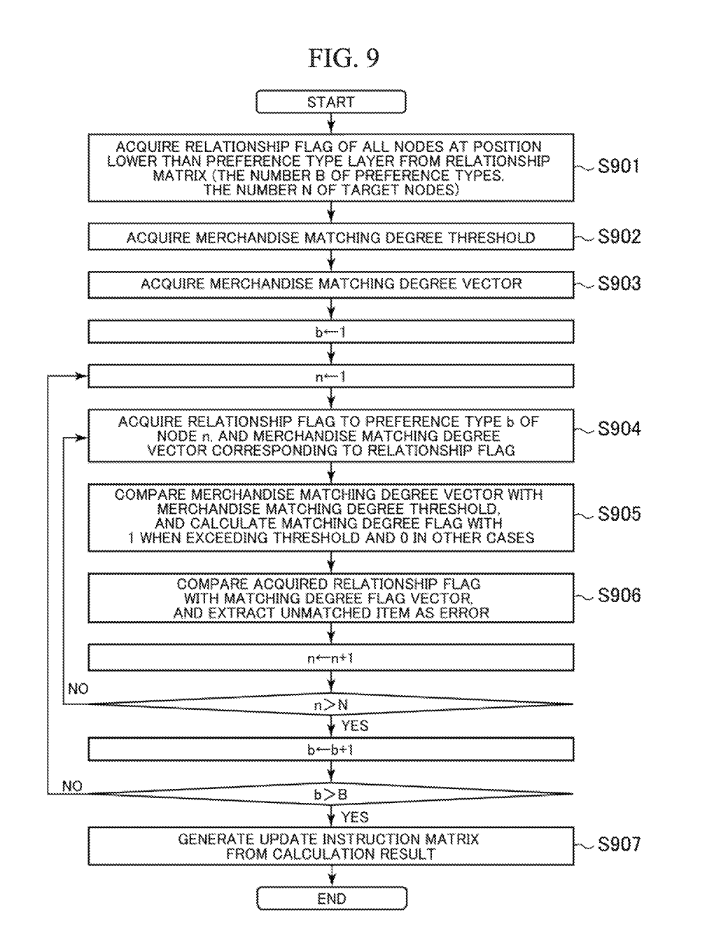

The merchandise matching degree analysis unit 331 generates the update instruction matrix data 335 on the basis of the merchandise matching degree vector 341 and the merchandise matching degree threshold. The details of the present step will be described with reference to FIG. 9.

### (FIG. 6: Steps S606 to S608)

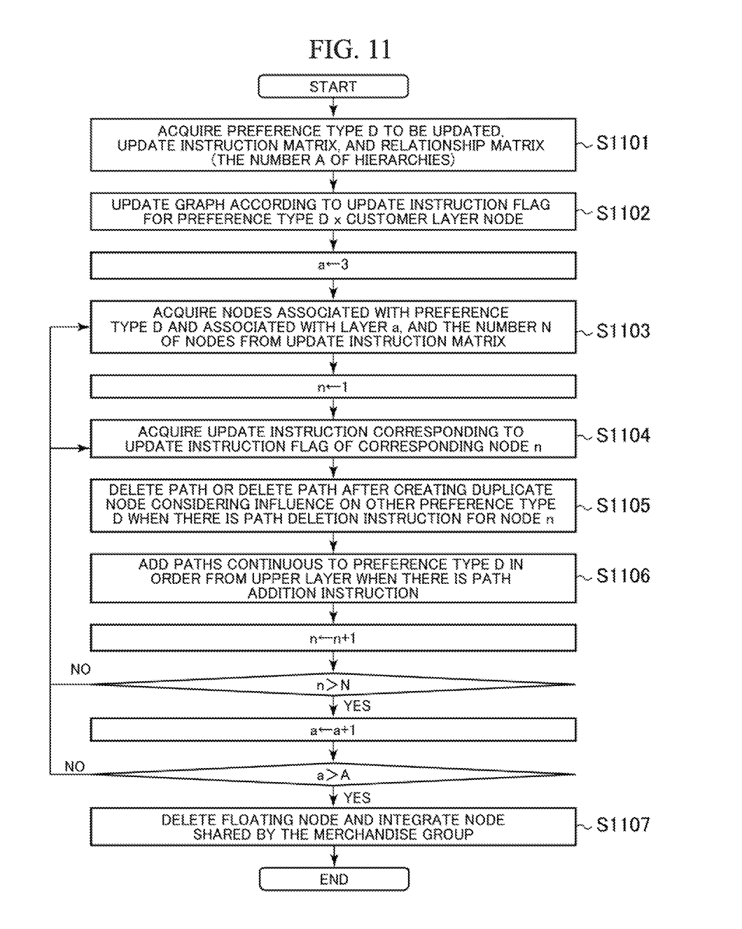

The display 360 presents an addition, deletion, and change draft of the path to the preference type according to the description of the update instruction matrix data 335 (S606). The evaluator 330 acquires, from the display 360, an instruction for designating the preference type for considering the path update (S607). The update unit 336 creates an addition and deletion draft of each node and path in association with the update of the preference type instructed at Step S607 (S608). The details of Step S608 will be described with reference to FIG. 11.

### (FIG. 6: Step S609)

The update unit 336 extracts a feature of the node updated at Step S608. The present step is to extract information for helping the business person in charge to interpret the preference type graph after updating. For example, when the paths in the merchandise attribute layer 130 and one layer above the merchandise attribute layer 130 are added and deleted, the update unit 336 extracts the features related to the added merchandise group and the deleted merchandise group. For example, a method is conceivable in which when the update unit 336 deletes the merchandise node 141 linked to the merchandise attribute node 131, the update unit 336 compares the merchandise name and the merchandise description of the merchandise group linked even after updating with the merchandise name and the merchandise description of the merchandise group to be deleted by updating, and extracts a characteristic keyword in the deleted merchandise group.

### (FIG. 6: Step S610 to S612)

The display 360 presents a node update draft and a node feature after updating (S610). The display 360 receives an instruction for updating the preference type graph from the business person in charge (S611). The update unit 336 generates the update version relationship matrix data 351 and the update history data 352 according to the instruction (S612).

FIG. 7 is a flowchart illustrating the details of S603. A purchasing trend of the customer belonging to a certain preference type node 121 is compared with a purchasing trend of the customer not belonging to the preference type node 121 whereby it can be estimated how much the customer segment classified by the preference type nodes 121 matches the actual purchasing trend. If both of those purchasing trends are separated from each other by some degree, it is considered that the preference type node 121 appropriately classifies the customer node 111. The merchandise matching degree analysis unit 331 calculates the merchandise matching degree on the basis of the above consideration. The respective steps in FIG. 7 will be described below.

### (FIG. 7: Step S701)

The merchandise matching degree analysis unit 331 acquires the relationship matrix data 311. The merchandise matching degree analysis unit 331 acquires the number A of hierarchies and a number B of preference types in the preference type graph from the relationship matrix data 311.

### (FIG. 7: Step S702)

The merchandise matching degree analysis unit 331 acquires a matrix (preference type×preference matrix) describing the customers belonging to each preference type from the preference type specific relationship data 382.

### (FIG. 7: Step S703)

The merchandise matching degree analysis unit 331 acquires a merchandise purchasing value vector of each customer from the purchasing history data 381. The merchandise purchasing value vector is data obtained by quantifying the purchasing trend of the customer for each merchandise. For example, the merchandise that has been purchased can be represented by a vector having an element value of 1, the merchandise that has not been purchased can be represented by a vector having an element value of 0. In addition to the presence or absence of the purchasing, a vector having the number of purchases, a purchasing rate, or the like as the element value can be used.

### (FIG. 7: Step S704)

The merchandise matching degree analysis unit 331 extracts the customer nodes 111 not belonging to the preference type nodes 121 including the merchandise nodes 141 for each merchandise node 141, calculates an average of the purchasing values of the extracted customer nodes 111 group, and sets the calculated average as a reference purchasing value of the merchandise node 141. The reference purchasing value is an index representing a purchasing trend of the customer node 111 not belonging to the preference type node 121 for the merchandise node 141. As the purchasing value, for example, 1/0 indicative of the presence or absence of the purchasing as at Step S703, or an appropriate index may be used if such an index is present.

### (FIG. 7: Step S705)

The merchandise matching degree analysis unit 331 calculates an average of the purchasing values of the customer nodes 111 group belonging to the preference type b for each merchandise.

### (FIG. 7: Step S706)

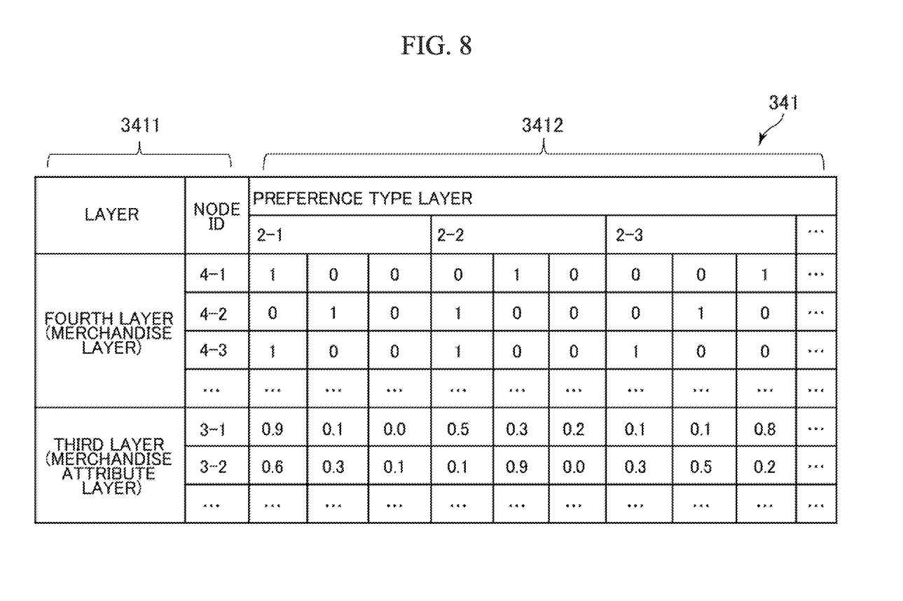

The merchandise matching degree analysis unit 331 calculates the merchandise matching degree vector for each preference type node 121 with reference to the purchasing reference value calculated at Step S704. A specific example of the merchandise matching degree vector will be described with reference to FIG. 8. The merchandise matching degree vector is data obtained by quantifying the purchasing trend of the customer nodes 111 group belonging to a certain preference type node 121 for each merchandise. For example, three values of (“likely to be purchased”, “average”, and “unlikely to be purchased”) are provided as the element values of the merchandise matching degree vector. If an average of the purchasing values for the merchandise is, for example, twice or more of the reference purchasing value, the merchandise matching degree vector is set to (1, 0, 0). If the average is, for example, equal to or less than ¼ of the reference purchasing value, the merchandise matching degree vector is set to (0, 0, 1). In other cases, the merchandise matching degree vector is set to (0, 1, 0). Each element value of the merchandise matching degree vector may not be always a discrete value. For example, the respective estimation probabilities of (“likely to be purchased”, “average”, and “unlikely to be purchased”) are set as the element values, and can be expressed as (0.9, 0.07, 0.03).

### (FIG. 7: Step S707)

The merchandise matching degree analysis unit 331 calculates the merchandise matching degree vector of a hierarchy a (one upper layer) from the merchandise matching degree vector related to a node of a hierarchy a+1 of the preference type graph. Specifically, the merchandise matching degree analysis unit 331 calculates an average vector of the merchandise matching degree vectors of the node of the hierarchy a+1 linked with each node of the hierarchy a as the merchandise matching degree vector of each vector of the hierarchy a.

### (FIG. 7: Step S708)

The merchandise matching degree analysis unit 331 implements Step S707 in order from a lower layer on the preference type graph. As a result, the merchandise matching degree vector 341 for each preference type node 121 is obtained.

FIG. 8 illustrates an example of the merchandise matching degree vector 341. An item 3411 indicates layers lower than the preference type layer 120 and node IDs in each layer. An item 3412 indicates node IDs belonging to the preference type layer 120. Three element values of the merchandise matching degree vector are described for each combination of the respective nodes in the preference type layer 120 with the respective nodes in the merchandise layer 140.

In the data example illustrated in FIG. 8, because, for example, the merchandise matching degree vector of the preference type node 2-1×the merchandise node 4-1 is (1, 0, 0), the customer nodes 111 belonging to the preference type node 2-1 has a trend of being likely to purchase the merchandise node 4-1 more than the customer nodes 111 not belonging to the preference type node 2-1. In addition, for example, the customer nodes 111 belonging to a preference type node 2-2 indicate that a rate of “unlikely to be purchased” in the merchandise nodes 141 belonging to the merchandise attribute node 3-1 is 0.2.

FIG. 9 is a flowchart illustrating the details of Step S605. It is conceivable that the customer node 111 belonging to some preference type node 121 linked with a certain merchandise node 141 has a trend of being likely to purchase the merchandise node 141 (in the case of the positive path) or being unlikely to purchase the merchandise node 141 (in the case of the negative path), compared with the customer node 111 not belonging to the preference type node 121. The positive path on the preference type graph corresponds to the element value “likely to be purchased” of the merchandise matching degree vector, and the negative path on the preference type graph corresponds to the element value “unlikely to be purchased” of the merchandise matching degree vector. Therefore, it is considered that as a difference between the purchasing trend indicated by the merchandise matching degree vector described in FIG. 8 and the path on the preference type graph is smaller, the preference type graph indicates the actual purchasing trend with higher precision. The merchandise matching degree analysis unit 331 generates the update instruction matrix data 335 so as to reduce the difference on the basis of the above consideration. Hereinafter, the respective steps in FIG. 9 will be described.

### (FIG. 9: Step S901)

The merchandise matching degree analysis unit 331 acquires a relationship flag (a cell value indicative of the presence or absence of the path and the type of the path) for all of the nodes in a layer lower than the preference type layer 120 from the relationship matrix data 311. The merchandise matching degree analysis unit 331 acquires the number B of preference types and the number N of nodes from the relationship matrix data 311.

### (FIG. 9: Step S902)

The merchandise matching degree analysis unit 331 acquires a merchandise matching degree threshold. The merchandise matching degree threshold is a threshold for determining to which of three element values of the merchandise matching degree vector a certain node belong (that is, any one of “likely to be purchased”, “average”, and “unlikely to be purchased”). The merchandise matching degree threshold may be set in advance, or may be designated by the business person in charge, for example, through the display 360.

### (FIG. 9: Step S903)

The merchandise matching degree analysis unit 331 acquires the merchandise matching degree vector 341.

### (FIG. 9: Step S904 and S905)

The merchandise matching degree analysis unit 331 acquires a relationship flag of the node n for the preference type b, and the merchandise matching degree vector corresponding to the relationship flag (S904). The merchandise matching degree analysis unit 331 compares the merchandise matching degree vector with the merchandise matching degree threshold, and calculates a matching degree flag as 1 if the merchandise matching degree vector exceeds the merchandise matching degree threshold, and 0 in the other cases (S905).

### (FIG. 9: Step S906)

The merchandise matching degree analysis unit 331 compares the relationship flag with the matching degree flag, and extracts the unmatched item as an error. If the relationship flag between the preference type b and the node n is 1, the merchandise matching degree vector means “likely to be purchased”. Therefore, if the merchandise matching degree vector is (1, 0, 0), those flags match each other, and in the other cases, those flags do not match each other. If there are multiple relationship flags between the preference type b and the node n, the merchandise matching degree analysis unit 331 compares the respective relationship flags with the matching degree flag, and considers a case where any one of those relationship flags does not match the matching degree flag as an error.

### (FIG. 9: Step S907)

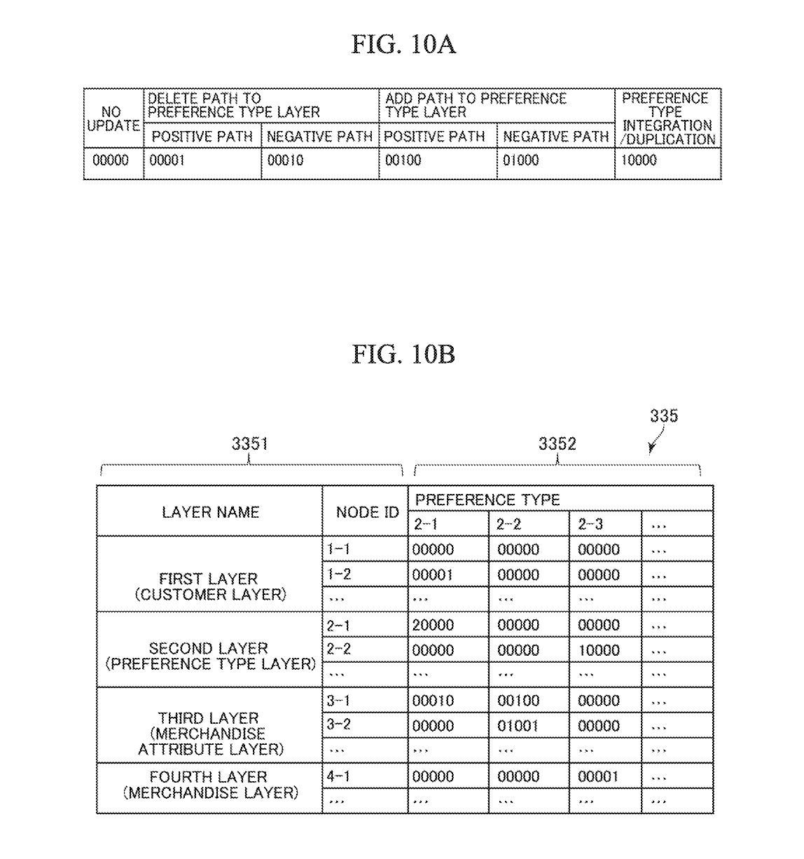

The merchandise matching degree analysis unit 331 performs the above steps for all of the preference types and the nodes, and generates the update instruction matrix data 335 on the basis of the result. The update instruction matrix data 335 is a matrix describing the update instruction for each preference type, and the detail of the update instruction matrix data 335 will be described with reference to FIGS. 10A and 10B.

FIG. 10A is a table illustrating the element value (update instruction flag) of the update instruction matrix data 335. The update instruction indicated by the update instruction flag is any one of (a) no update, (b) the deletion of the positive path from the preference type layer 120, (c) the deletion of the negative path from the preference type layer 120, (d) the addition of the positive path to the preference type layer 120, (e) the addition of the negative path to the preference type layer 120, and (f) the integration/duplicate of the preference type. Each update instruction is expressed by the update instruction flag, for example, as illustrated in FIG. 10A. When multiple instructions for a certain preference type and a certain node are present, the respective update instruction flags are added together whereby the multiple instructions are represented by one update instruction flag.

FIG. 10B is a diagram illustrating a configuration of the update instruction matrix data 335. An item 3351 indicates the node IDs in each layer. An item 3352 is the nodes IDs belonging to the preference type layer 120. The update instruction flag is described for each combination of the respective nodes in the preference type layer 120 with the respective nodes in each layer.

The update instruction flag of any one of no update, a positive path deletion, and a positive path addition is described between the preference type layer 120 and the customer layer 110. According to the data example illustrated in FIG. 10B, the positive path between the customer node 1-2 and the preference type 2-1 is instructed to be deleted.

The update instruction flag between the nodes in the preference type layer 120 is any one of no change, and integration/duplicate of the preference type. In the example illustrated in FIG. 10B, since the update instruction flag indicative of the integration/duplicate between the preference type node 2-2 and the preference type node 2-3 is designated, those nodes are integrated together to create a new node. Since the update instruction flag indicative of the integration/duplicate of the preference type for the same node is designated in the preference type node 2-1, the preference type node 2-1 is divided. Because a value of the update instruction flag is 20000 (that is, two duplicate instructions), the preference type node 2-1 is duplicated to create two nodes.

The update instruction flag in a layer lower than the preference type layer 120 is any one of no change, the deletion of the positive path, the deletion of the negative path, the addition of the positive path, and the addition of the negative path. Multiple instructions may be combined together. According to the data example illustrated in FIG. 10B, an instruction is given to delete the positive path and add the negative path between the preference type node 2-2 and the merchandise attribute node 3-2.

FIG. 11 is a flowchart illustrating the details of S608. Hereinafter, the respective steps in FIG. 11 will be described.

### (FIG. 11: Step S1101)

The update unit 336 acquires a preference type D to be updated, the update instruction matrix data 335 corresponding to the preference type D, the relationship matrix data 311, and the number A of hierarchies on the relationship matrix data 311.

### (FIG. 11: Step S1102)

The update unit 336 acquires the update instruction flag for the node belonging to the preference type D and the customer layer 110, updates the path of the preference type graph or integrates/duplicates the preference type node 121 according to the acquired instruction.

### (FIG. 11: Steps S1103 and S1104)

The update unit 336 acquires the node that has the update instruction related to the preference type D and is related to the layer a from the update instruction matrix data 335, and acquires the number N of nodes (S1103). The update unit 336 acquires the update instruction flag of the node n (S1104).

### (FIG. 11: Step S1105)

When a path deletion instruction for the node n is present, the update unit 336 checks influence of the path deletion on the other preference type D with reference to the relationship flag between the node n and the other preference type D. When the correspondence relationship of the other preference type D is changed by the path deletion, the path is deleted as it is. When the connection relationship of the other preference type D is changed by the path deletion, after the other preference type D is prevented from being influenced by duplicating the node n, the instructed path is deleted.

### (FIG. 11: Step S1106)

When the path addition instruction for the node n is present, the update unit 336 adds the path continuous to the preference type D in order from the higher position. Specifically, it is first checked whether or not an instruction for adding the node continuous to the preference type D node or the preference type D is present in a layer a-1. If the instruction is present, the update unit 336 adds the path for the node. If no instruction is present, the update unit 336 generates the node and the path in the layer a-1 so that the path is continuous to the preference type D. After having added the node or the path in the layer a-1, the update unit 336 changes the update instruction flag for a lower position node belonging to the node n to “no change”. The update unit 336 adds the path in order from the higher position, and a change from the initial design data 301 is reduced by preventing the lower node belonging to the added path from being updated. In other words, the update unit 336 can generate the update draft high in the merchandise matching degree while having a graph structure as near as the preference type graph initially designed.

### (FIG. 11: Step S1107)

The update unit 336 deletes the nodes in which the upper path continuous to the preference type layer 120 is not present and the nodes in which the lower path continuous to the merchandise layer 140 is not present, in the update draft of the preference type graph created in the above steps. Further, the update unit 336 integrates the nodes shared by the lower merchandise group together. The update unit 336 outputs the update draft of the preference type graph created in the above steps.

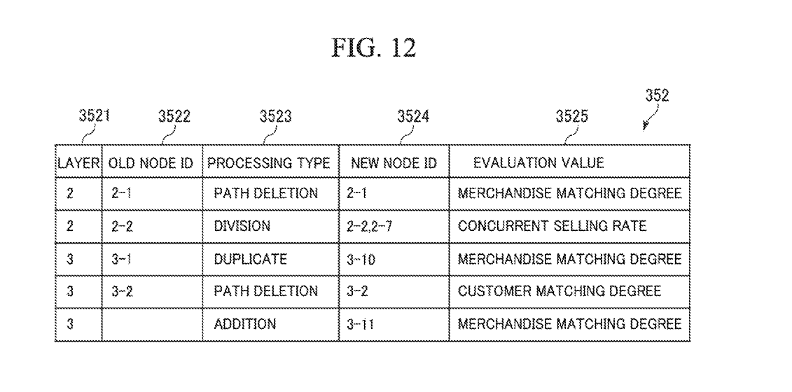

FIG. 12 is a diagram illustrating a configuration example of the update history data 352. The update unit 336 records the log as the update history data 352 every time the addition, duplicate, deletion, integration and the division of the node on the preference type graph, and the addition and deletion of the path between the nodes are implemented.

A layer 3521 is an ID of the layer to which the updated node belongs before updating. An old node ID 3522 records (a) the deleted or divided node ID, (b) the integrated node ID group, and (c) the upper side node ID when the path between the nodes is added or deleted. A blank is provided in the case of adding the node. A processing type 3523 records the content of the update process or the update instruction flag. A new node ID 3524 describes the node ID after updating. A blank is provided in the case of deleting the node. An evaluation value 3525 describes the evaluation index used when calculating the update instruction matrix data 335. In the above description, an example in which the update instruction matrix data 335 is calculated on the basis of the merchandise matching degree was described. The other evaluation index will be described later.

### First Embodiment: Evaluation Based on Customer Matching Degree

Because the customer nodes 111 linked to the same preference type node 121 are linked to the same purchasing psychological factor, it is assumed that portions associated with the purchasing psychological factor have the similar purchasing trend. The customer matching degree is an index indicative of the degree of similarity of the purchasing trend of the customer nodes 111 group. Using the customer matching degree, it is possible to evaluate whether a group of merchandise nodes 141 linked with a preference type node 121 is purchased in a similar manner by a group of customer nodes 111 belonging to such preference type node 121.

The estimation of whether the purchasing trend is similar or not may not be appropriate depending on the concept of the designed preference type nodes 121. For example, in the case of designing the preference type “fond of tobacco”, the customers belonging to such preference type purchases the tobacco in common. However, because the tobacco brands preferred by individuals are dispersed, a case where the purchasing trends taking the brands into consideration are dispersed among the customers belonging to the preference type is conceivable. Under the circumstances, for example, (a) the threshold for determining the degree of similarity of the customer matching degree may be determined, and (b) whether to implement the evaluation according to the customer matching degree or not may be determined, according to the concept of the preference type, to thereby evaluate only the necessary preference type.

FIG. 13 is a flowchart illustrating the details of S502. Hereinafter, the respective steps in FIG. 13 will be described.

### (FIG. 13: S1301 and S1302)

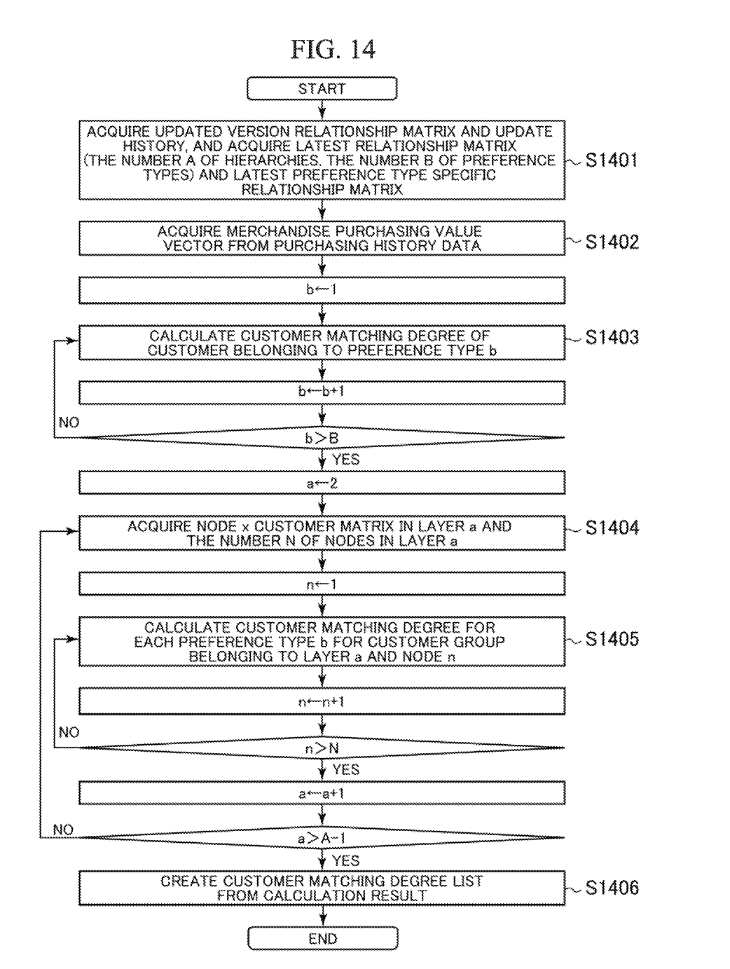

The evaluator 330 acquires the relationship matrix data 311, the preference type specific relationship data 382, the update version relationship matrix data 351, and the update history data 352 (S1301). The customer matching degree analysis unit 332 calculates the customer matching degree list 342 (S1302). The details of Step S1302 will be described with reference to FIG. 14.

### (FIG. 13: Step S1303)

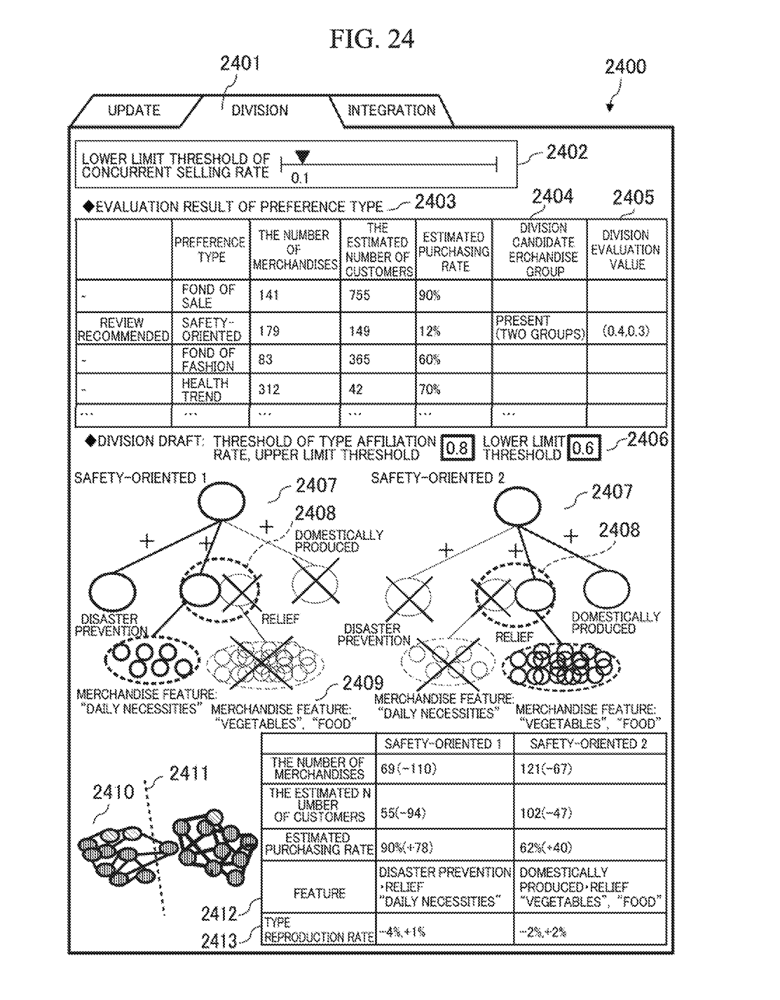

The evaluator 330 acquires the customer matching degree threshold from the display 360. A screen interface for designating the customer matching degree threshold will be described with reference to FIG. 24 to be described later.

### (FIG. 13: Step S1304)

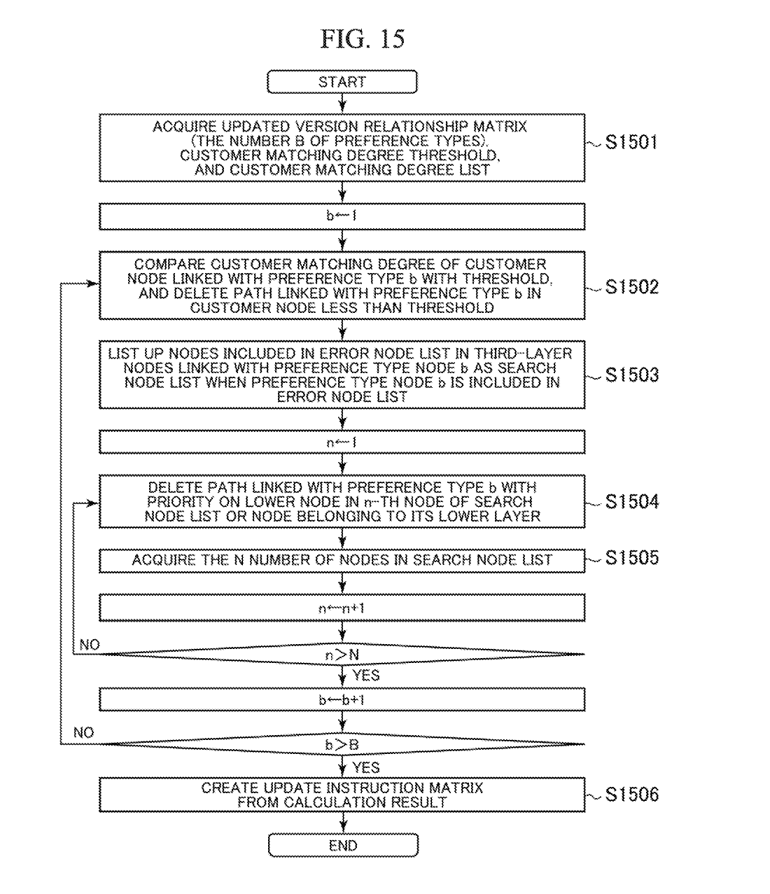

The update unit 336 calculates the update instruction matrix data 335 on the basis of the customer matching degree list 342 and the customer matching degree threshold. The details of the present step will be described with reference to FIG. 15.

### (FIG. 13: Steps S1305 to S1307)

The display 360 presents the addition, deletion, and change draft of the path for the preference type according to the description of the update instruction matrix data 335 (S1305). The evaluator 330 acquires an instruction for designating the preference type for consideration of the path update from the display 360 (S1306). The update unit 336 creates the addition and deletion draft of each node and path in association with updating of the preference type instructed at Step S1306 (S1307).

### (FIG. 13: Steps S1308 to S1311)

The update unit 336 extracts the feature of the node updated at Step S1307 in the same technique as that at Step S609 (S1308). The display 360 presents the node update draft and the node feature after updating (S1309). The display 360 receives an instruction for updating the preference type graph from the business person in charge (S1310). The update unit 336 generates the update version relationship matrix data 351 and the update history data 352 (S1311).

FIG. 14 is a flowchart illustrating the details of Step S1302. It is conceivable that the customer node 111, the purchasing trend of which is different from the other customer nodes 111, in the customer nodes 111 group belonging to a certain preference type node 121 should not belong to the preference type node 121. Under the circumstances, the customer matching degree analysis unit 332 calculates how much the purchasing trends of the customer nodes 111 match each other (customer matching degree). The customer matching degree list 342 is a data file for recording the calculation result. Hereinafter, the respective steps in FIG. 14 will be described.

### (FIG. 14: Step S1401)

The customer matching degree analysis unit 332 acquires the update version relationship matrix data 351 and the update history data 352. Further, the customer matching degree analysis unit 332 acquires the latest-version relationship matrix data 311 and the latest-version preference type specific relationship data 382. For example, the customer matching degree analysis unit 332 acquires the correspondence relationship between the nodes before and after updating from the update history data 352, and allocates the preference type specific relationship data 382 to the node after updating, thereby being capable of acquiring the latest-version preference type specific relationship data 382. When the pre-update node is not present, or when the node making it difficult to estimate the matrix because a change from the pre-update is larger is present, those nodes may be omitted from the processing target in the present flowchart.

### (FIG. 14: Step S1402)

The customer matching degree analysis unit 332 acquires the merchandise purchasing value vector of each customer from the purchasing history data 381. The merchandise purchasing value vector is a vector having a value (purchasing value) representing whether to purchase each merchandise, by a numeric value such as 1/0 as the element value.

### (FIG. 14: Step S1403)

The customer matching degree analysis unit 332 acquires a portion describing whether or not the customer belonging to the preference type b has purchased the merchandise belonging to the preference type b from the merchandise purchasing value vectors acquired at Step S1402. The customer matching degree analysis unit 332 obtains an average vector of the acquired merchandise purchasing value vectors. The customer matching degree analysis unit 332 can determine whether the purchasing trend of each customer matches the purchasing trend of the other customer, on the basis of a distance between the average vector and the merchandise purchasing value vector of each customer. For example, the customer matching degree analysis unit 332 can determine that the purchasing trend of each customer matches the purchasing trend of the other customer if the distance falls within a predetermined range. The customer matching degree of the customer, the purchasing trend of which matches the purchasing trend of the other customer is set as 1, and the customer matching degree of the unmatched customer is set as 0. Alternatively, a reciprocal of the distance may be set as the customer matching degree.

### (FIG. 14: Step S1403: Supplemental No. 1)

The method of calculating the customer matching degree is not limited to the above method. For example, a technique is proposed in which the merchandise purchasing value vectors of the respective customers are clustered, the customer matching degrees of the customers classified into a representative class is set as 1, and the customer matching degree of the customers classified in a class smaller in scale than a predetermined threshold is set as 0.

### (FIG. 14: Step S1403: Supplemental No. 2)

The present step is to obtain the customer matching degree between the customer nodes 111 paying attention to only the customer layer 110. On the contrary, in the layers lower than the preference type layer 120, because there is a possibility that multiple paths extending to the customer nodes 111 are present, and that the customer nodes 111 are counted redundantly, the redundancy is eliminated through AND operation at Step S1405. However, the concept of the customer matching degree is the same as that of the following step. Similarly, in FIG. 15, for the same reason, only the customer layer 110 is processed in advance, and the preference type layer 120 and the subsequent layers are thereafter processed.

### (FIG. 14: Step S1404)

The customer matching degree analysis unit 332 acquires the relationship flag between each node and the customer nodes 111 in the layer a, and the number N of nodes in the layer a.

### (FIG. 14: Step S1405)

The customer matching degree analysis unit 332 calculates the customer matching degree for the customer nodes 111 belonging to the node n in the layer a and also belonging to the preference type b. Specifically, the customer matching degree analysis unit 332 calculates an average vector of the merchandise purchasing value vectors of the customer nodes 111 belonging to the node n in the layer a and also belonging to the preference type b, and calculates the customer matching degree on the basis of a distance between the average vector and the merchandise purchasing value vector of each customer.

### (FIG. 14: Step S1405: Supplemental)

The technique of calculating the customer matching degree in the present step is not limited to the above technique. For example, the matching degree between the nodes may be calculated on the basis of an index related to a variation in the merchandise purchasing value vector group. In the flowchart illustrated in FIG. 14, the customer matching degree related to the merchandise layer 140 is not calculated. However, the customer matching degree can be calculated on the basis of a rate at which the customer belonging to the preference type b purchases each merchandise node 141. When there is no need to take the customer matching degree in the lower layer into consideration, the customer matching degree to an arbitrary layer may be calculated, and the evaluation of the preference type graph based on the customer matching degree may not be implemented on the nodes where the customer matching degree has not been calculated.

### (FIG. 14: Step S1406)

The customer matching degree analysis unit 332 creates the customer matching degree list 342 on the basis of the calculation results in the above steps. The customer matching degree list 342 is data describing the customer matching degree of all nodes to be calculated in the above steps.

FIG. 15 is a flowchart illustrating the details of Step S1304. Among merchandise groups linked with a preference type b, while keeping paths to merchandise groups with high customer matching degree, the update unit 336 creates an update draft for deleting paths to merchandise groups with diverse purchase trends. Hereinafter, the respective steps in FIG. 15 will be described.

### (FIG. 15: Step S1501)

The update unit 336 acquires the update version relationship matrix data 351 and the customer matching degree list 342. The update unit 336 acquires the customer matching degree threshold from the display 360. For example, when the customer matching degree depends on population such that the method of calculating the customer matching degree is different for each layer, or a statistical dispersion index is employed as the customer matching degree, multiple customer matching degree thresholds may be prepared.

### (FIG. 15: Step S1502)

The update unit 336 compares the customer matching degree of each node linked with the preference type b with the customer matching degree threshold. The update unit 336 adds the nodes, the customer matching degree of which is less than the threshold, to an error node list. The update unit 336 allocates an update instruction flag for instructing the customer nodes 111 included in the error node list to delete the paths linked with the preference type b in the present step. In the layers lower than the preference type layer 120, the paths are deleted in favor of the lowermost layer in the following steps.

### (FIG. 15: Step S1502: Supplemental)

With the deletion of the paths of the node, the customer matching degree of which is less than the threshold, the customers, the purchasing trend of which is different from that of the other clients can be removed from the preference type. In addition, with the deletion of the paths in priority order from the lowermost layer, the preference type graph that matches the purchasing history data 381 with high precision while a change from the initial design data 301 is reduced can be realized.

### (FIG. 15: Step S1503)

When the preference type node d is included in the error node list, the update unit 336 acquires a third-layer node linked with the preference type node b, and lists up the nodes included in the error node list in the third-layer nodes as a search node list.

### (FIG. 15: Step S1504 and S1505)

The update unit 336 allocates the update instruction flag for instructing the nodes in the search node list or the nodes belonging to the lower layer to delete the paths linked with the preference type b in favor of the lower nodes. Specifically, the update unit 336 first acquires an n-th node of the search node list. When the n-th node is in the lowermost layer, the update unit 336 allocates the update instruction flag for giving an instruction for deleting the paths linked to the preference type b. When the n-th node is not in the lowermost layer, the update unit 336 adds the nodes in the error node list linked with an n-th node from one lower layer to the search node list. The update unit 336 implements the same processing for N nodes in the search node list, to thereby delete the path linked with the preference type b in favor of the lowermost layer node in the search node list.

### (FIG. 15: Step S1506)

The update unit 336 creates the update instruction matrix data 335 on the basis of the above calculation results.

### First Embodiment: Node Division

FIG. 16 is a flowchart illustrating the details of S503. Hereinafter, the respective steps in FIG. 16 will be described.

### (FIG. 16: Step S1601 and S1602)

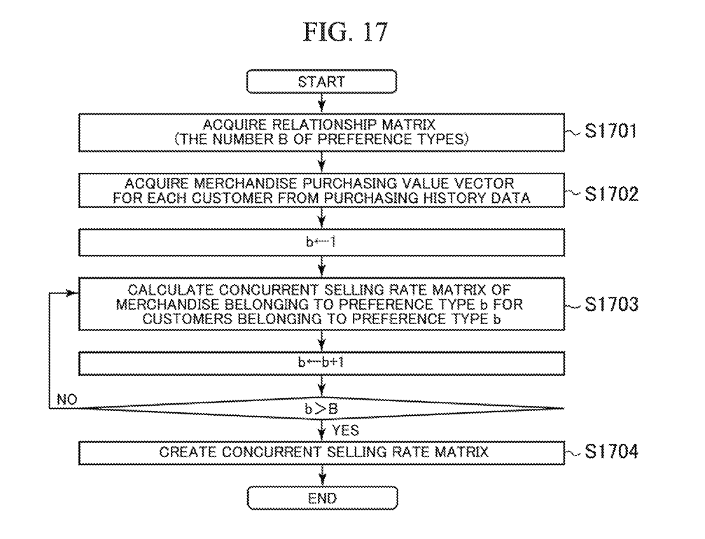

The division analysis unit 333 acquires the relationship matrix data 311, the preference type specific relationship data 382, the update version relationship matrix data 351, and the update history data 352 (S1601). The division analysis unit 333 calculates the concurrent selling rate matrix 343 (S1602). The details at Step S1602 will be described with reference to FIG. 17.

### (FIG. 16: Step S1603)

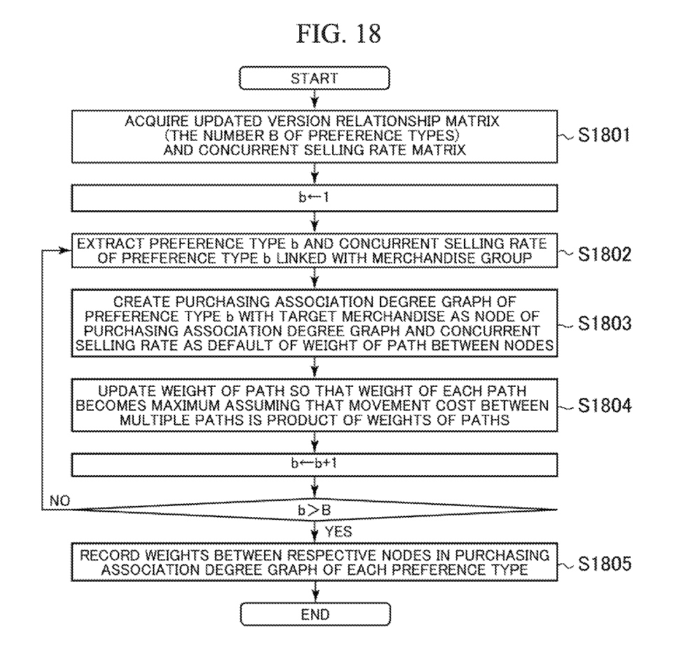

The division analysis unit 333 creates a purchasing association degree graph related to the merchandise group linked with the preference type. The purchasing association degree graph is a graph that includes additional paths between the nodes not linked with each other on the preference type graph. With the use of the purchasing association degree graph, the division analysis unit 333 attempts to couple the merchandise groups likely to be associated in the actual purchasing trend although not associated on the preference type graph. The details of the present step will be described with reference to FIG. 18.

### (FIG. 16: Step S1604)

The display 360 acquires a lower limit threshold of the merchandise concurrent selling rate and an upper limit/lower limit threshold of a division type affiliation rate. The lower limit threshold of the merchandise concurrent selling rate is a threshold used for determination in extracting the merchandise group linked with each preference type when a certain preference type is divided. The upper limit/lower limit threshold of the division type affiliation rate is a threshold used for determining the update draft for dividing the preference type while maintaining a structure of the preference type graph before updating as much as possible after the merchandise group has been extracted. A screen for acquiring those thresholds will be described with reference to FIG. 24.

### (FIG. 16: Step S1605)

The division analysis unit 333 cuts an edge having the concurrent selling rate that is equal to or less than the lower limit threshold in the purchasing association degree graph generated at Step S1603, to thereby extract a preference type specific division candidate merchandise group. The preference type specific division candidate merchandise group is a merchandise group having a predetermined or more purchasing association degree in the purchasing association degree graph of a certain preference type, which is a merchandise group high in the purchasing association degree in a part of customer aggregation in the customer group belonging to the preference type. In other words, it is conceivable that with the setting of the preference type linked with the division candidate merchandise group, the preference type graph in which the matching degree between the merchandise group actually purchased by the customer group belonging to the preference type and the merchandise group linked by the preference type is higher can be set.

### (FIG. 16: Step S1606)

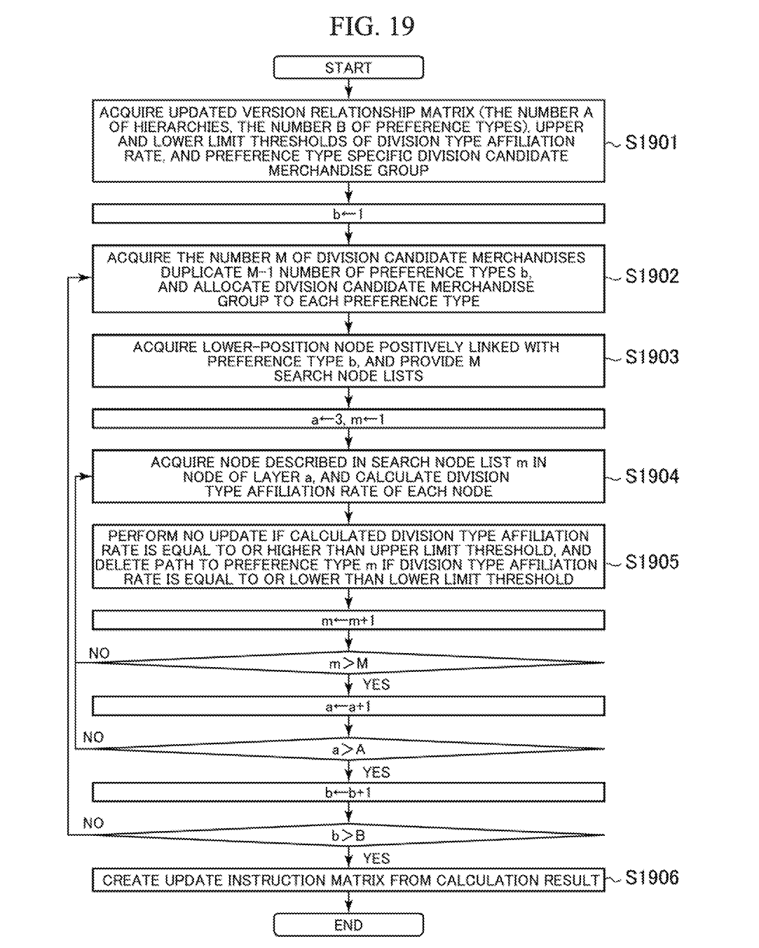

The division analysis unit 333 calculates the update instruction matrix data 335 on the basis of the preference type specific division candidate merchandise group extracted at Step S1605. The details of the present step will be described with reference to FIG. 19.

### (FIG. 16: Step S1607 to S1609)

The display 360 presents a division likelihood of the preference type according to the disclosure of the update instruction matrix data 335 (S1607). The evaluator 330 acquires an instruction for designating the preference type for consideration of the division from the display 360 (S1608). The update unit 336 extracts a structure draft of a preference type graph in which the instructed preference type is divided and a division rate of the preference type (S1609).

### (FIG. 16: Step S1610)

The update unit 336 extracts the feature of the node updated at Step S1609 in the same technique as that at Step S609. The display 360 presents the node update draft and the node feature after updating.

### (FIG. 16: Step S1611 and S1612)

The display 360 receives an instruction for updating the preference type graph from the business person in charge (S1611). The update unit 336 creates the update version relationship matrix data 351 and the update history data 352 (S1612).

FIG. 17 is a flowchart illustrating the details of Step S1602. The division analysis unit 333 analyzes an association trend between the merchandises purchased by a person belonging to a certain preference type, to thereby calculate the concurrent selling rate matrix 343. Hereinafter, the respective steps in FIG. 17 will be described.

### (FIG. 17: Step S1701)

The division analysis unit 333 acquires a correspondence relationship between the preference type nodes 121 and the customer nodes 111 from the relationship matrix data 311. It is assumed that the number of acquired preference types is B.

### (FIG. 17: Step S1702)

The division analysis unit 333 acquires the merchandise purchasing value vector of each customer from the purchasing history data 381. The style of describing the merchandise purchasing value vector is the same as the one described above.

### (FIG. 17: Step S1703)

The division analysis unit 333 calculates the concurrent selling rate matrix for each preference type. More specifically, the division analysis unit 333 calculates a person number rate of persons who purchases both of two merchandises to the customers belonging to a certain preference type b, and outputs the calculated person number rate as the concurrent selling rate matrix of the preference type b. The concurrent selling rate used in the present step may be an index for evaluating the purchasing association degree between two merchandises, and the concurrent selling rate does not always need to be calculated on the basis of the number of persons who have purchased those two merchandises. For example, a probability with the condition in which both of a merchandise A and a merchandise B are purchased can be used as the concurrent selling rate. In that case, a purchasing probability P(B|A) of the merchandise B when a certain customer purchases the merchandise A, and a purchasing probability P(A|B) of the merchandise A when the customer purchases the merchandise B are calculated, respectively, and an average value of those probabilities of the customer group belonging to the preference type b is used as the concurrent selling rate of the preference type b. The concurrent selling rate is a value equal to or more than 0 and equal or less than 1.

### (FIG. 17: Step S1704)

The division analysis unit 333 implements Step S1703 for all of the preference types, and stores the implemented result in the concurrent selling rate matrix 343.

FIG. 18 is a flowchart illustrating the detail of S1603. Even if no path is present between the merchandise nodes 141 on the preference type graph (that is, no association), simultaneous purchasing may be performed on the purchasing history data 381. Under the circumstances, the division analysis unit 333 creates the purchasing association degree graph linking the respective merchandise nodes 141 with each other in the present flowchart. The purchasing association degree graph has the purchasing association degree between the merchandise nodes 141 as a weight of the path between the merchandise nodes 141. Hereinafter, the respective steps in FIG. 18 will be described.

### (FIG. 18: Step S1801)

The division analysis unit 333 acquires the update version relationship matrix data 351 and the concurrent selling rate matrix 343. It is assumed that the number of preference types in the update version relationship matrix data 351 is B.

### (FIG. 18: Step S1802)

The division analysis unit 333 extracts the concurrent selling rate of the preference type b from the concurrent selling rate matrix 343 for the merchandise group linked with the preference type b on the preference type graph.

### (FIG. 18: Step S1803)

The division analysis unit 333 creates the purchasing association degree graph of the preference type b with the merchandise group extracted at Step S1802 as the node of the purchasing association degree graph and the concurrent selling rate as a default of the weight of the path between the nodes. When the concurrent selling rate matrix 343 is an asymmetrical graph, the respective weights are expressed with the use of paths having orientation.

### (FIG. 18: Step S1804)

The division analysis unit 333 updates the weight of the path so that the weight of each path is maximized with a travel cost between the multiple paths as a product of the weights of the paths. A path travel route between a node n1 and a node n2 is expressed as n1→n2, a path travel route going through a node n3 is expressed as n1→n3→n2, and the travel cost in the route of n1→n2 is expressed as W (n1→n2). The travel cost of an arbitrary path travel route is expressed as the following Expression 1 with the use of the product of the travel cost of the path route.

W(n1→n3→n2)=W(n1→n3)×W(n3→n2) (Ex. 1)

Further, the travel cost between the node n1 and the node n2, and the cost of the travel path of m1 to mM(M≦N) through which the travel from the node n1 to the node n2 goes are required to satisfy the following Expression 2. N is the number of all nodes in the purchasing association degree graph.

W(n1→n2)≧W(n1→m1→ . . . →mM→n2) (Ex. 2)

The division analysis unit 333 obtains a W(n1→n2) in all of the nodes satisfying (Ex. 1) and (Ex. 2) after departing from the path of a default. The default of W(n1→n2) is the concurrent selling rate of the merchandise n2 with respect to the merchandise n1, and the concurrent selling rate ranges from 0 to 1. Therefore, the travel cost when the node m is added to the travel path n1→n2 always satisfies the following Expression 3. The division analysis unit 333 updates the weight so that W(n1→n2) is maximized taking the above fact into consideration.

W(n1→n2)≧W(n1→n2→m) (Ex. 3)

### (FIG. 18: Step S1804: Supplemental)

The technique of calculating the weights of the purchasing association degree graph is not limited to the above technique. For example, the path may be updated taking only the routes of several merchandises into consideration. In addition, the weights are determined in advance when the weights of the purchasing association degree graph are calculated, and all of the weights falling below a threshold are regarded as 0 whereby only the paths, the weight of which is large to some extent may be considered. Further, the default of the purchasing association degree graph may be employed as it is.

### (FIG. 18: Step S1805)

The division analysis unit 333 implements the above steps for all of the preference types b, and records the weights between the nodes in the purchasing association degree graph of each preference type.

FIG. 19 is a flowchart illustrating the details of Step S1606. In the present flowchart, the update unit 336 creates an update draft for dividing the preference type while maintaining the structure of the preference type graph before updating as much as possible. Hereinafter, the respective steps in FIG. 19 will be described.

### (FIG. 19: Step S1901)

The update unit 336 acquires the update version relationship matrix data 351. The update unit 336 acquires upper limit/lower limit thresholds of the division type affiliation rate from the display 360. The update unit 336 acquires the preference type specific division candidate merchandise group. It is assumed that the number of hierarchies is A and the number of preference types is B in the update version relationship matrix data 351.

### (FIG. 19: Step S1902 to S1906: Supplemental)

Among update drafts that satisfy the upper/lower limit thresholds of the division type affiliation rate, the update unit 336 creates an update draft for dividing the preference type only by adding and deleting paths in the upper layer as much as possible. Alternatively, the update unit 336 may determine the upper limit value of the number of update processing steps, and search the division draft best in that range. The effectiveness of the division draft can be evaluated by: comparing the division candidate merchandise group with merchandise groups that are linked with the subject preference type by adding and deleting a certain node or a path; and checking how small the number of merchandises not belonging to the division candidate merchandise group but belonging to the subject preference type is. Hereinafter, a description will be given on the assumption that a technique of adding or deleting the paths in order from the upper layer is employed.

### (FIG. 19: Step S1902)

The update unit 336 acquires the number M of division candidate merchandises of the preference type b. The update unit 336 duplicates (M-1) pieces of the preference type b, and allocates the respective division candidate merchandises to the preference type b and the duplicated (M-1) preference types.

### (FIG. 19: Step S1903)

The update unit 336 acquires the lower layer node positively linked with the preference type b, and sets the acquired lower layer node as a search node list. The update unit 336 creates M pieces of search node lists. In the present step, the nodes to be searched are set as all nodes, thereby being capable of considering a draft for adding a positive node capable of preferably dividing the division candidate merchandise group.

### (FIG. 19: Step S1904)

The update unit 336 acquires the nodes described in the search lead list m among the nodes in the layer a, and calculates the division type affiliation rate of each node. The division type is each preference type duplicated at Step S1902. The affiliation rate can be calculated by a rate at which each division candidate merchandise group belongs to each division preference type on the purchasing history data 381. The search node list m is a list of the search nodes related to the division candidate merchandise group m.

### (FIG. 19: Step S1905)

If the division type affiliation rate calculated at Step S1904 is equal to or more than an upper limit threshold, the update unit 336 gives an update instruction flag indicating that a relationship flag between the node and the preference type m is not updated, and deletes the lower layer node linked with the node from the search node list m. If the division type affiliation rate is equal to or lower than the lower limit threshold, the update unit 336 gives an update instruction flag indicating that the path between the node and the preference type m is deleted, and deletes the lower layer node linked with the node from the search node list m.

### (FIG. 19: Step S1905: Supplemental)

When a rate at which the division candidate merchandise group belongs to the division preference type is equal to or more than an upper limit threshold, the update unit 336 does not update the preference type graph for nodes in the layer lower than the node. In other words, the update unit 336 updates the preference type graph with priority from the upper layer. As a result, the preference type can be properly divided while reducing a difference between the preference type graphs before and after updating.

### (FIG. 19: Step S1906)

The update unit 336 creates the update instruction matrix data 335 on the basis of the calculation result of the above steps. For example, the update unit 336 adds a line describing the node ID belonging to the duplicated preference type node 121 on a line corresponding to each nodes in the preference type layer 120, and describes an update instruction flag designating a relationship flag of the node in the other layer of the new preference type nodes 121 to the added line.

### First Embodiment: Node Integration

FIG. 20 is a flowchart illustrating the details of S504. The integration analysis unit 334 evaluates the degree of similarity between the preference type nodes 121, and proposes integration probabilities. The degree of similarity between the preference type nodes 121 includes the matching degree of the customer nodes 111 linked with the respective preference type nodes 121, the matching degree of the merchandise nodes 141 belonging to the respective preference type nodes 121, the matching degree of the purchasing trend to the merchandise nodes 141 group after the preference type has been integrated, and so on. FIG. 20 illustrates an example in which the matching degree of the purchasing trend is evaluated. Hereinafter, the respective steps in FIG. 20 will be described.

### (FIG. 20: Step S2001 to 2002)

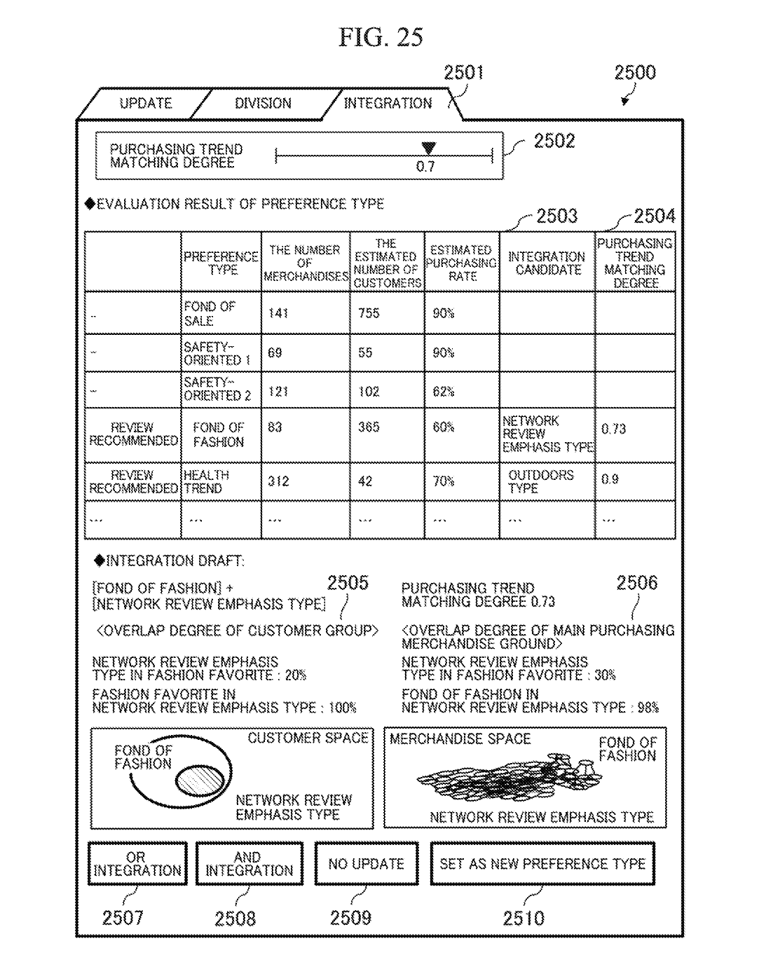

The integration analysis unit 334 acquires the relationship matrix data 311, the merchandise matching degree vector 341, the update version relationship matrix data 351 (the number B of preference types), and the update history data 352 (S2001). The display 360 acquires a threshold of the purchasing trend matching degree (S2002). A screen for designating the threshold of the purchasing trend matching degree will be described with reference to FIG. 25.

### (FIG. 20: Step S2003)

The integration analysis unit 334 compares the merchandise matching degree vectors related to the merchandises linked with a preference type b1 and preference type b1 with each other for the respective customer groups of the preference types b1 and b1, and calculates the purchasing trend matching degree. For example, the correlation coefficient between a merchandise matching degree vector of the preference type b1 and the merchandise matching degree vector of the preference type b1 can be set as the purchasing trend matching degree.

### (FIG. 20: Step S2004)

The integration analysis unit 334 compares the purchasing trend matching degree calculated at Step S2003 with a purchasing trend matching degree threshold acquired at Step S2002, and extracts an integration candidate node pair. The node pair in which the purchasing trend matching degree is equal to or more than the threshold can be set as an integration candidate.

### (FIG. 20: Step S2005 to S2008)

The integration analysis unit 334 creates the update instruction matrix data 335 on the basis of the integration candidate node pair extracted at Step S2004 (S2005). The display 360 presents an integration draft of the preference type nodes 121 according to the description of the update instruction matrix data 335 (S2006). The display 360 acquires an integration instruction of the preference type (S2007). The update unit 336 updates the update version relationship matrix data 351 and the update history data 352 according to the instruction (S2008).

### First Embodiment: Feature of Post-Update Node

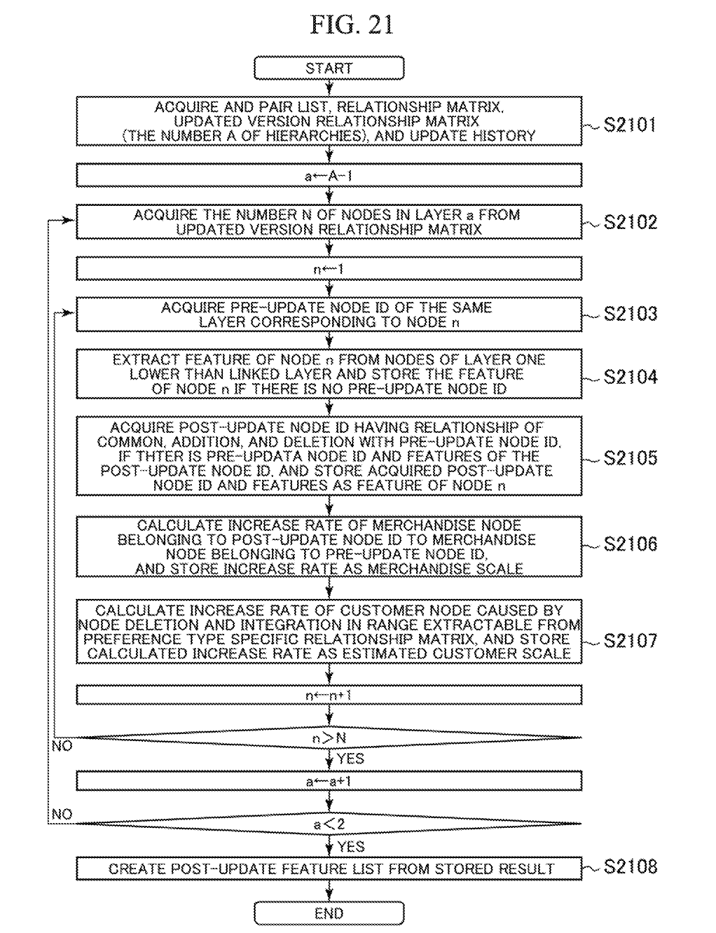

FIG. 21 is a flowchart illustrating a process of creating the post-update feature list 383. The updater 370 creates the post-update feature list 383 using the update parameter 350 outputted from the evaluator 330 and using the update instruction data 303 acquired by the display 360 as inputs, and presents the preference type graph after updating and the post-update feature list 383 through the display 360. The updater 370 receives each node name of the preference type graph after updating from the business person in charge, and finally updates the design data 310. The post-update feature list 383 is a list describing the feature of each node of the preference type graph after updating. Hereinafter, the respective steps in FIG. 21 will be described.

### (FIG. 21: Steps S2101 to S2103)

The updater 370 acquires the AND pair list 312, the relationship matrix data 311, the update version relationship matrix data 351 (the NUMBER A OF HIERARCHIES), and the update history data 352 (S2101). The updater 370 acquires the number N of nodes in the layer a from the update version relationship matrix data 351 (S2102). The updater 370 acquires the node ID before updating in the same layer corresponding to the node n from the update history data 352 (S2103).

### (FIG. 21: Step S2104)

When the pre-update node ID corresponding to the node n is not present, the updater 370 extracts the feature of the node n from the node in one lower layer linked with the node n, and stores the extracted feature as the feature of the node n.

### (FIG. 21: Step S2105)

When the node n and the corresponding pre-update node ID are present, the updater 370 compares the pre-update node ID with the relationship flag of the node n, to thereby acquire the post-update node ID, the added post-update node ID, and the deleted post-update ID, which are shared by the pre-update node ID, and stores the features of those post-update node IDs as the feature of the node n.

### (FIG. 21: Step S2106)

The updater 370 extracts the merchandise nodes 141 group belonging to the respective nodes before and after updating. The updater 370 calculates an increase rate of the number of merchandise nodes 141 belonging to the post-update node ID to the number of merchandise nodes 141 belonging to the pre-update node ID, and stores the calculated increase rate as the merchandise scale.

### (FIG. 21: Step S2107)

The updater 370 calculates the increase rate of the customer nodes 111 in association with the deletion and integration of the node in a range extractable in the preference type specific relationship data 382, and stores the calculated increase rate as an estimated customer scale.

### (FIG. 21: Step S2108)

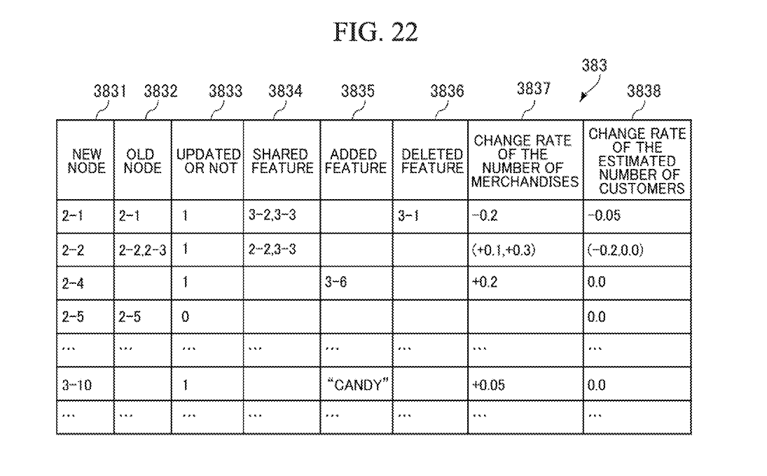

The updater 370 creates the post-update feature list 383 on the basis of the results of the above steps. A specific example of the post-update feature list 383 will be described with reference to FIG. 22.

FIG. 22 is a diagram illustrating an example of the post-update feature list 383. A new node 3831 and an old node 3832 hold the nodes IDs before and after updating. An update presence/absence flag 3833 is a flag indicative of whether the subject node has been updated or not. A common feature node ID 3834, an additional feature node ID 3835, and a deleted feature node ID 3836 are a node ID having a common feature between the nodes before and after updating, a node ID having a feature added between the nodes before and after updating, and a node ID having a feature deleted between the nodes before and after updating, respectively. A merchandise number change rate 3837 is a change rate of the number of merchandise nodes 141 linked with the node after updating to the number of merchandise nodes 141 linked with the node before updating. If the multiple nodes before updating are present, the change rates to the respective nodes before updating are recorded. An estimated customer number change rate 3838 is a change rate of the estimated number of customers belonging to the subject node. It is conceivable that when the merchandise nodes 141 group linked with a certain preference type is changed, an estimated customer belonging to the preference type is also changed. Therefore, the change rate related to before and after updating is recorded in the present field. Accurate paths between the customer nodes 111 and the preference type nodes 121 are estimated by the preference type estimator 320.

At Step S2108 to create the post-update feature list 383, the preference type estimator 320 may calculate the number of estimated customers in the preference type graph after updating, or may calculate an estimated value of the number of customers in the preference type graph after updating on the basis of the number of customers in the preference type graph before updating. For example, when a path between a certain preference type nodes 121 and the merchandise attribute node 131 is deleted, it is probable that correspondence relationships between the customer nodes 111 belonging to only the merchandise attribute node 131 whose path is deleted in the customer nodes 111 belonging to the preference type nodes 121 and the preference type nodes 121 are also deleted. From this viewpoint, the number of customer nodes 111 to be deleted can be estimated.

FIG. 23 illustrates a screen configuration example of a matching degree setting screen 2300 presented by the display 360. The matching degree setting screen 2300 is a screen for the business person in charge to input an instruction to the customer analysis device 300 at Steps S501 and S502. A tab 2301 is a selection tab for displaying the matching degree setting screen 2300, and when the business person in charge clicks the tab 2301, the matching degree setting screen 2300 is displayed. The other tabs will be described with reference to FIGS. 24 and 25.

A check box 2302 is a check box for selecting whether or not Step S501 for evaluating the preference type graph on the basis of the merchandise matching degree is to be implemented. A check box 2303 is a check box for selecting whether or not Step S502 for evaluating the preference type graph on the basis of the merchandise matching degree is to be implemented. The evaluator 330 implements the step (both the steps may be selected) selected by those check boxes. A threshold designation field 2304 is a field for designating a threshold. In FIG. 23, because only the check box 2302 is selected, only a slider bar for designating the merchandise matching degree threshold at Step S902 is displayed. On the other hand, when the check box 2303 is selected, a slider bar for designating the customer matching degree threshold at Step S1303 is also displayed.

An evaluation result summary 2305 presents a summary of the evaluation results of the preference type graph in the Step selected by the above check boxes. A preference type 2307 represents the evaluated preference type nodes 121. The number of merchandises 2308 is the number of merchandises linked with the preference type 2307 before updating. An estimated customer number 2309 is the number of customers estimated to belong to the preference type 2307 before updating. An estimated purchasing rate 2310 is an evaluation index for the update draft of the preference type 2307, which is a rate of the merchandise nodes 141 determined to be likely to be purchased on the purchasing history data 381 to the merchandise nodes 141 linked to the preference type 2307 on the preference type graph. The estimated purchasing rate 2310 can be calculated from the merchandise matching degree vector 341 or the customer matching degree list 342. An update draft 2311 is a summary of the update draft of the preference type graph. A review recommendation flag 2306 suggests a review for the evaluation index of the preference type 2307 when the evaluation index is low. The information to be presented is not limited to the above information, but for example, as the number of merchandises 2308, only the number of merchandises linked with the positive path may be presented.

A path update draft 2312 presents an update draft for the preference type graph by the step selected by the above check boxes. In this example, the path update draft 2312 presents the update draft for the preference type “fond of sale” suggested to be reviewed by the review recommendation flag 2306. A preference type graph 2313 shows a graph of the preference type in which the nodes and the paths which are linked with the preference type before updating are indicated by solid lines, and the node and the path which are added after updating are indicated by dotted lines. A check box 2314 is an entry field for instructing the customer analysis device 300 to actually add the node proposed to be added. A check box 2315 is an entry field for instructing the customer analysis device 300 to actually delete the node proposed to be deleted. A merchandise feature 2316 is a feature common to the deletion candidate merchandise group. A link 2317 is a link for transitioning a detailed merchandise list to a presentation screen. The number of merchandises 2318, the estimated number of customers 2319, and an estimated purchasing rate 2320 indicate those estimated values after updating the node. An update button 2321 is a button for confirming the path update draft 2312. A non-update button 2322 is a button for entering a fact that the path update draft 2312 is not adopted.

FIG. 24 is a screen configuration example of a division setting screen 2400 presented by the display 360. The division setting screen 2400 is a screen for the business person in charge to input an instruction to the customer analysis device 300 at Step S503. A tag 2401 is a selection tab for displaying the division setting screen 2400, and when the business person in charge clicks a tab 2401, the division setting screen 2400 is displayed.

A threshold setting field 2402 is a field for designating a lower limit threshold of the merchandise concurrent selling rate at Step S1604. When the lower limit threshold of the merchandise concurrent selling rate is low, even when the purchasing association degree between the merchandises by the same customer is not too high, those merchandises are linked with the same preference type. Therefore, as compared with a case where the lower limit threshold is high, the number of extracted division candidate merchandise groups is liable to be reduced.

An evaluation result summary 2403 presents an evaluation result of the preference type graph. The review recommendation flag to the estimated purchasing rate are the same items as those in the evaluation result summary 2305 in FIG. 23. A division candidate merchandise group 2404 is a division draft for the preference type graph at Step S503, and presents the number of division candidate merchandise groups. A division evaluation value 2405 is an index related to a likelihood of each preference type when the preference type is divided on the basis of the division candidate merchandise group 2404. In this example, an average value of the weights of the paths between the respective nodes in the purchasing association degree graph after the preference type has been divided is presented as the division evaluation value 2405. It is assumed that when the division evaluation value 2405 is higher, the customer nodes 111 and the merchandise nodes 141 can be more appropriately classified according to the preference type corresponding to the division candidate merchandise group 2404.

A threshold designation field 2406 is a field for designating an upper limit threshold/lower limit threshold of a division type affiliation rate at Step S1604. A division graph 2407 presents a node division draft for a preference type “safety-oriented” suggested to be reviewed by the review recommendation flag in the evaluation result summary 2403. In FIG. 24, an update draft for dividing a merchandise attribute node 2408 is presented with the division of the preference type node “safety-oriented”. A division graph 2407 presents the node groups and the paths linked with the node after division as much as possible. A merchandise feature 2409 presents the feature of the merchandise nodes 141 group in the lower layer as the feature of the node after division.

A purchasing association degree graph 2410 is a division image of the purchasing association degree graph created in a flowchart of FIG. 18. A dotted line 2411 indicates a division boundary of the merchandise groups to be divided by the division draft in a merchandise space. The purchasing association degree graph 2410 is expressed by the connection of the paths in the network between the merchandise nodes 141, and the quality of the update draft can be visually grasped by comparison with the division graph 2407.

A feature 2412 is a feature of the merchandise groups linked with the preference type after division. A type reproduction rate 2412 is an evaluation value of each preference type when the preference type is divided on the basis of the division candidate merchandise group 2404, and represents a rate of the non-matched merchandise group in the division candidate merchandise group and the actual division result. In an example illustrated in FIG. 24, −4% indicates a rate of the merchandises that are present in the division candidate merchandise group but no longer present at the time of the actual division, and +1% indicates a rate of the merchandises that are not present in the division candidate merchandise group but present at the time of the actual division. The other items in the same table are the same as the respective items in the evaluation result summary 2403.

Although omitted for ease of viewing in FIG. 24, the division setting screen 2400 also includes an update button and a non-update button identical with those in FIG. 23. As in FIG. 23, whether to update, or not, can be selected for each of the nodes/paths.

FIG. 25 illustrates a screen configuration example of an integration setting screen 2500 presented by the display 360. The integration setting screen 2500 is a screen for the business person in charge to enter an instruction to the customer analysis device 300 at Step S504. A tab 2501 is a selection tab for displaying the integration setting screen 2500, and when the business person in charge clicks the tag 2501, the integration setting screen 2500 is displayed.

A threshold setting field 2502 is a field for designating a threshold of the purchasing trend matching degree at Step S2202. The evaluation result summary presents the evaluation result of the preference type graph. The review recommendation flag to the estimated purchasing rate are the same items as those in the evaluation result summary in FIG. 23. An integration candidate 2503 is an integration draft for the preference type graph at Step S504. An purchasing trend matching degree 2504 is an index for likelihood of the integration result.

A customer overlapping degree field 2505 presents the degree of overlapping of the customer group belonging to each preference type integrally proposed. As illustrated in FIG. 25, the customer overlapping degree field 2505 may present a rate of the customer nodes overlapping between the preference types, or may visually present the degree of overlapping in the customer space. A purchasing merchandise overlapping degree field 2506 illustrates the degree of overlapping between the merchandise nodes, for example, in the purchasing association degree graph in the merchandise space. In addition, the purchasing merchandise overlapping degree field 2506 may present the same information as that in the evaluation result summary 2305 in FIG. 23. In FIG. 25, the review recommendation flag presents a node integration draft for the preference types “fond of fashion” and “network review emphasis type”. In FIG. 25, only one of the integration patterns subjected to review recommendation is displayed on a screen. Alternatively, all of the integration patterns subjected to the review recommendation may be displayed on the screen in bulk.

An OR integration button 2507 instructs the customer analysis device 300 to integrate the respective preference types together in an OR relationship. An AND integration button 2508 instructs the customer analysis device 300 to integrate the respective preference type together in an AND relationship. A non-update button 2509 cancels the integration. A new preference type button 2510 instructs the customer analysis device 300 to create a new preference type that integrates the respective preference types together.

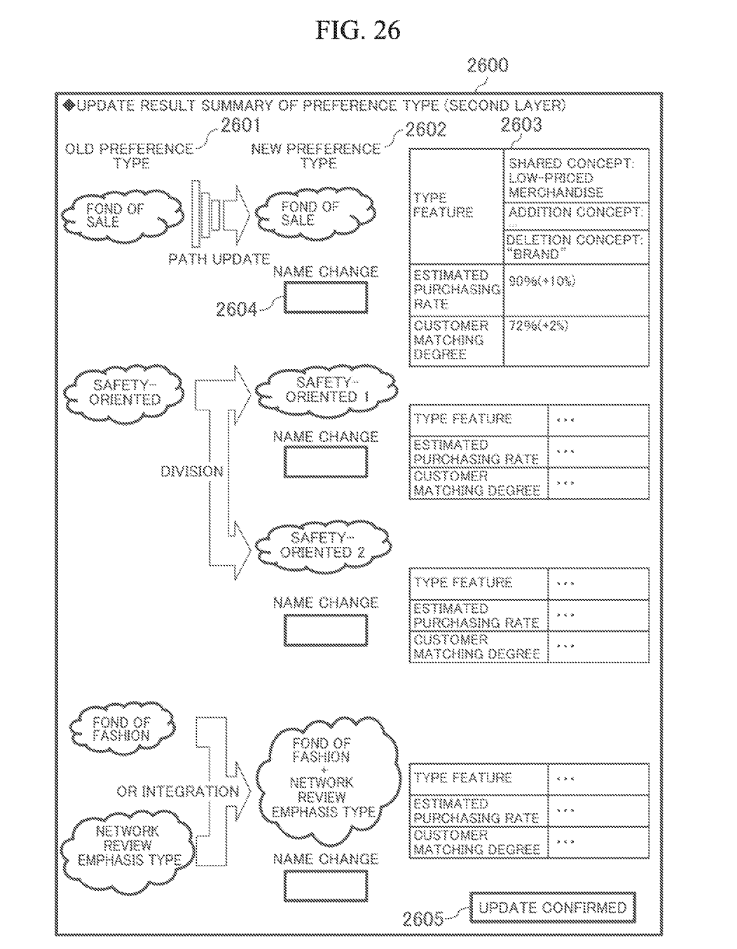

FIG. 26 illustrates a screen configuration example of an update result screen 2600 on which the display 360 displays an update result of the preference type based on the post-update feature list 383. In this example, the update result screen 2600 presents a structure change before and after updating related to the preference type layer 120. An old preference type 2601 and a new preference type 2602 are names of the respective preference types before and after updating. A feature field 2603 presents a type feature, an estimated purchasing rate, and a customer matching degree related to the new preference type. The estimated purchasing rate and the customer matching degree are indexes for likelihood of the preference type. The business person in charge inputs an appropriate name for describing the new preference type to an input receiving unit 2604 taking the information presented by the type feature into account. Upon depressing an update confirmation button 2605, the updater 370 updates the design data 310.

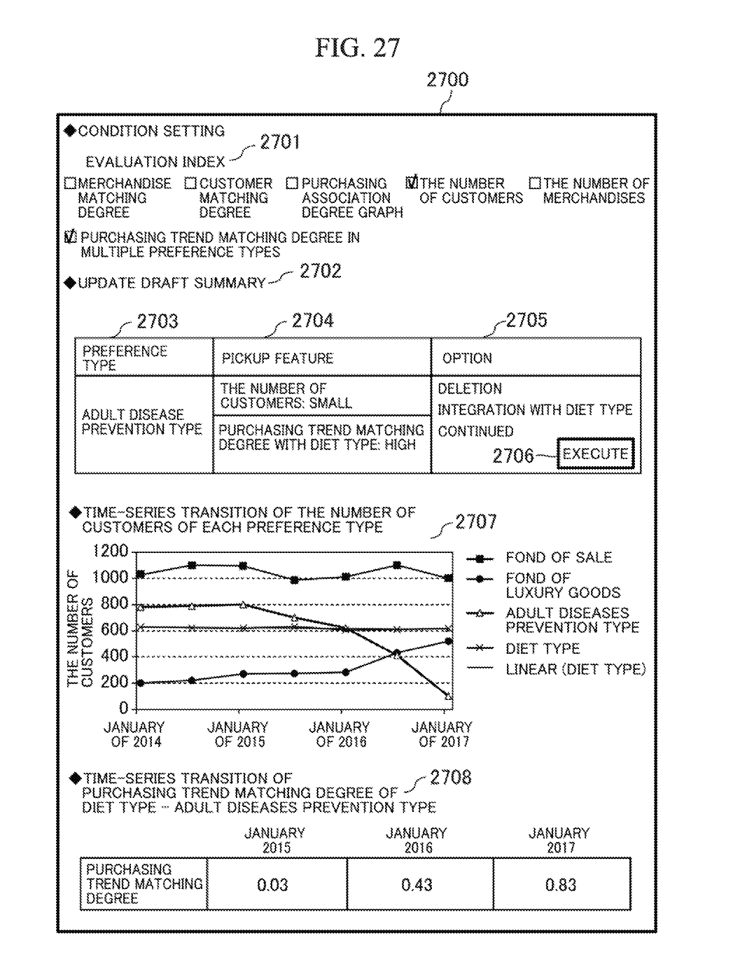

FIG. 27 illustrates a screen configuration example of a time series screen 2700 presented by the display 360. The time series screen 2700 is a screen that presents a result of analyzing the purchasing history data 381 with separated periods, and analyzing a time-series transition of the evaluation index related to the preference type graph.

An analysis condition input unit 2701 is a field for selecting the index used in the analysis. An update drift summary 2702 presents an update draft of the preference type graph based on a change in the time-series evaluation index. A preference type 2703 is a preference type name updated and proposed. A pickup feature 2704 represents a trend of the evaluation index that is a basis of the update proposal. FIG. 27 illustrates that the purchasing trend matching degree between an adult disease prevention type and a diet type with a characteristic trend related to the purchasing trend matching degree between the multiple preference types as an analysis condition. An option 2705 proposes candidates of available options. When an execution button 2706 is depressed, the updater 370 executes the update content selected in the option 2705.

A time-series graph 2707 is a graph indicative of a time-series transition of the number of customers of each preference type, and indicates an trend of reducing the number of customers of the preference type 2703 (adult disease prevention type). A time-series table 2708 illustrates a time-series transition of a purchasing trend matching degree of the diet type and the adult disease prevention type. In FIG. 27 shows a trend of increasing the purchasing trend matching degree with time, as a result of which a possibility that the diet type and the adult disease prevention type are integrated together is suggested.

### First Embodiment: Conclusion

As has been described above, the customer analysis device 300 according to the first embodiment can propose the preference type graph that brings the purchasing preference type (concept related to the purchasing psychological factor) designed by the business person in charge closer to the actual merchandise purchasing history. As a result, the customer analysis device 300 can reduce the try & error in the preference type design of the customers, and further can cope with a conceptual change in the purchasing preference type with time.

### Second Embodiment

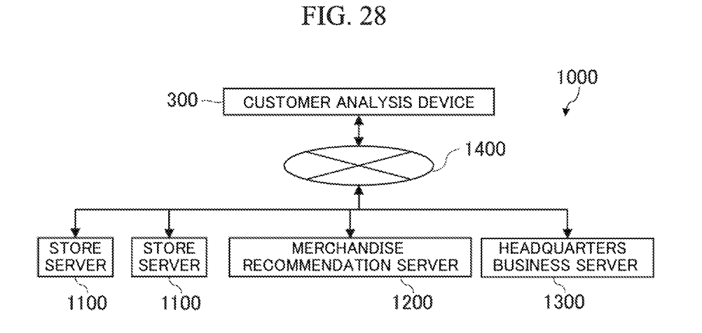

FIG. 28 is a configuration diagram of a customer analysis system 1000 according to a second embodiment of the present invention. The customer analysis system 1000 is a system for helping to design a preference type, and is connected to a customer analysis device 300 described in the first embodiment, one or more store servers 1100, a merchandise recommendation server 1200, and a headquarters business server 1300. Those devices are connected to each other by a network 1400.

The store server 1100 transmits a possessed purchasing history (purchasing history data 381) to the customer analysis device 300, and tallies the analysis result caused by the customer analysis device 300, for example, each customer in the subject store, to thereby present data to be leveraged in a business in the store to a store server user. The merchandise recommendation server 1200 acquires a recommendation merchandise and an appropriate recommendation message for each individual from the analysis result caused by the customer analysis device 300, and creates the merchandise recommendation for each individual. The headquarters business server 1300 is a server that leverages the analysis results caused by the customer analysis device 300 to a retail related business such as a CRM business or a new merchandise development business. For example, a leveraging method of presenting a relationship with a person number scale of each preference type or a demographic attribute as the analysis result, and helping the concept consideration of the new merchandise development is conceivable.

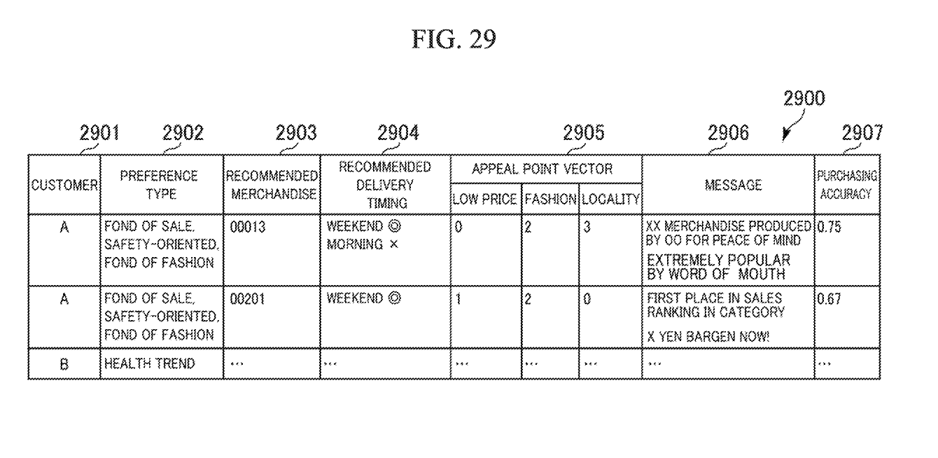

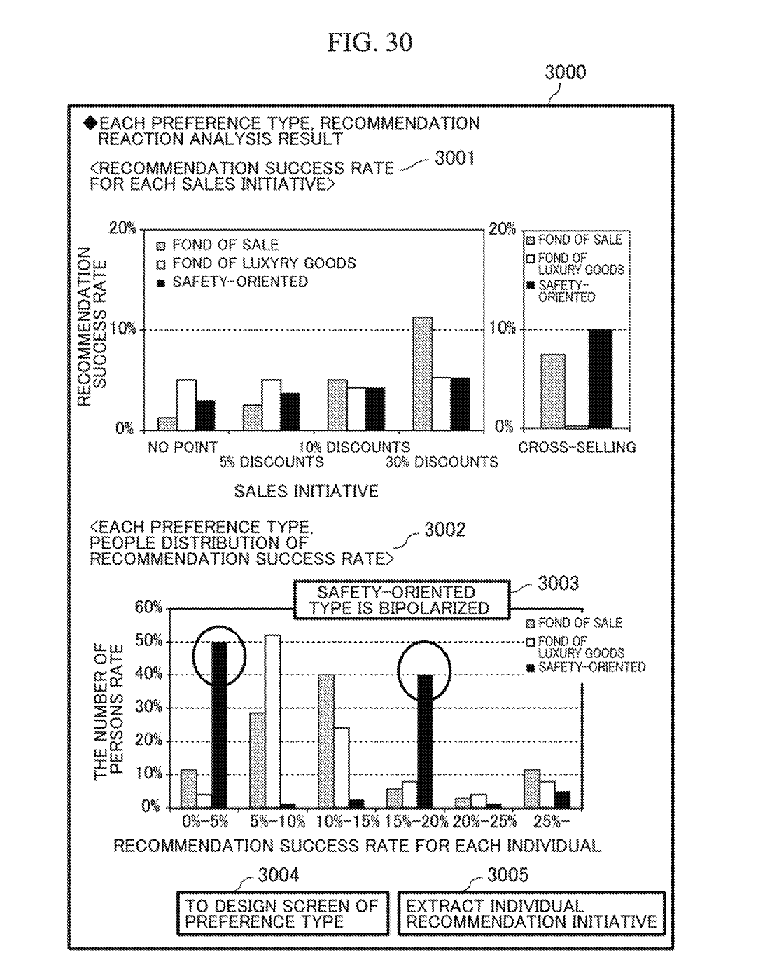

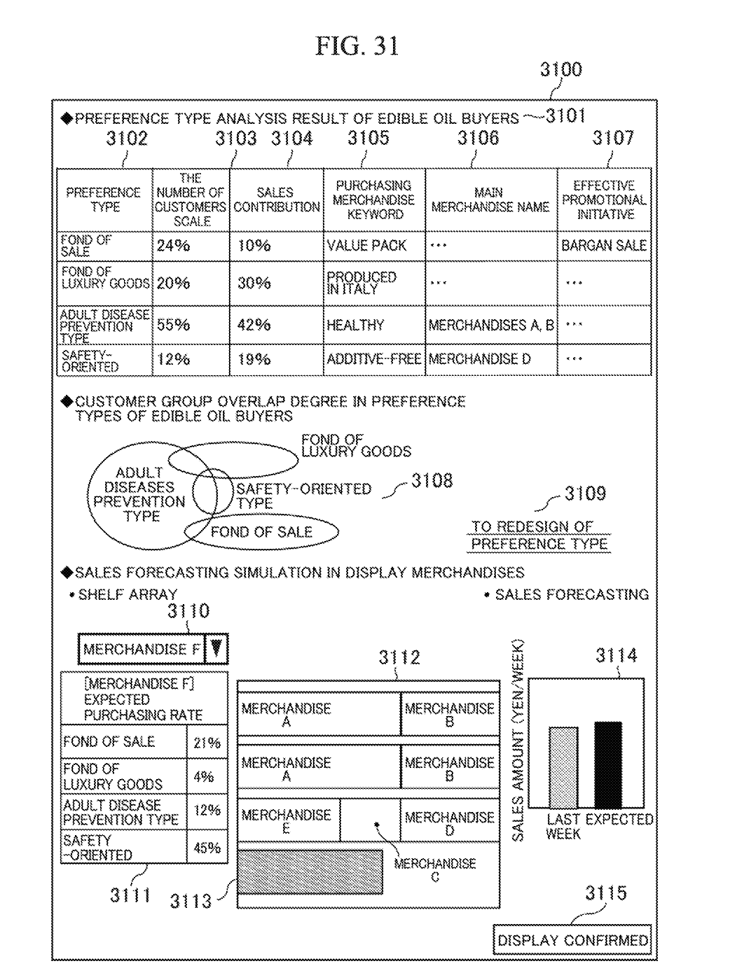

FIG. 29 illustrates an example of a recommendation matrix 2900 describing merchandise recommendation measures determined on the basis of the analysis result by the customer analysis device 300. The recommendation matrix 2900 can generate any one of the tore servers 1100, the merchandise recommendation server 1200, and the headquarters business server 1300. The same is applied to information and screens illustrated in FIGS. 30 and 31 to be described later.

A customer 2901 is an ID of each customer. A preference type 2902 is a preference type to which the customer 2901 belongs. A recommended merchandise 2903 is a merchandise linked with a preference type to which the customer 2901 belongs. A preference type graph may be designed regarding a purchasing time or a Web site browsing time that are linked with the customer ID, for example. A recommended delivery timing 2904 is extracted according to the designed preference type graph. An appeal point vector 2905 is a vector calculated by multiplying the merchandise feature of the recommended merchandise 2903 by the path between the preference type nodes 121 to which the customer 2901 belongs and the merchandise attribute nodes 131. In this situation, it is interpreted that the index such as the customer matching degree is a contribute degree to the preference type of each customer 2901, and the appeal point vector 2905 can be calculated according to the contribute degree. A message 2906 is a message that is generated on the basis of the weight of the appeal point vector 2905. A purchasing probability 2907 is an index value that indicates ease to purchase the merchandises belonging to the preference type. The purchasing probability 2907 is estimated on the basis of the concurrent selling rate matrix 343 with respect to the merchandise group belonging to the preference type linked with the customer 2901 and a past purchasing trend of the customer 2901. It is conceivable that with the user of the purchasing probability 2907, the merchandise higher in appeal power than the provision of the merchandise recommendation measures by using only the preference type graph can be extracted.

FIG. 30 illustrates a screen configuration example of a recommended reaction analysis screen 3000 used when the business person in charge analyzes a reaction of the customer to the merchandise recommendation measures determined on the basis of the analysis result caused by the customer analysis device 300. A recommendation success rate 3001 is a graph calculating a recommendation success rate to sales measures represented by the axis of abscissa in the graph for each preference type of the customers. A recommendation success rate person number distribution 3002 is a graph showing a person number distribution of the recommendation success rate in which the axis of abscissa denotes the recommendation success rate for each customer, and the axis of ordinate is a person number rate. According to the recommendation success rate person number distribution 3002, since it is found that the success rate of the safety-oriented type is bipolarized, a message 3003 indicative of that fact is presented. A button 3004 is a button for shifting to a design screen of the preference type. A button 3005 is a button for shifting to a process of extracting the individual recommendation measures without changing the preference type. Upon receiving the analysis result illustrated in FIG. 30, the business person in charge considers appropriate recommendation association measures according to the preference type, or redesigns the preference type so as to extract the recommended recommendation merchandise high in the recommendation success rate.

FIG. 31 illustrates a screen configuration example of a display consideration screen 3100 used when the business person in charge considers the type of the display merchandise and an on-the-shelf placement in a store on the basis of the analysis result caused by the customer analysis device 300. An analysis result 3101 presents an analysis result for considering a planogram related to the merchandise (edible oil in FIG. 31) in the store. The analysis result includes a preference type 3102 for purchasing the merchandise, a customer number scale 3103 of the preference type 3102, a sales contribution 3104 of the preference type 3102, a keyword 3105 of the merchandise purchased by the preference type 3102, a main merchandise name 3106 purchased by the preference type 3102, effective promotional measures 3107, and so on.

A customer group overlapping degree 3108 is a customer group overlapping degree between the preference types of a person who has purchased the subject merchandise (edible oil in FIG. 31). For example, the overlapping of the customer group aggregation of the preference type in the customer space can be used. A link 3109 is a transition link for shifting to a resign screen of the preference graph, and is used when wanting to grasp a more detailed preference type or when wanting to design the preference type specific to the store. An expected purchasing rate 3111 is an expected purchasing rate for each preference type of the merchandise selected in the option 3110. A shelf placement 3112 is a shelf layout in the store. When the business person in charge selects an area 3113 and sets the merchandise to be placed, a sales forecast 3114 is implemented taking a store-coming-person distribution for each preference type into account. When a display confirmation button 3115 is clicked, a display currently displayed is confirmed.

### <Modifications of the Present Invention>

The respective embodiments of the present invention have been described above. However, the present invention includes various modifications without departing from the subject matter of the present invention. For example, in the abovementioned embodiments, in order to easily understand the present invention, the specific configurations are described. However, the present invention does not always provide all of the configurations described above. Also, a part of one configuration example can be replaced with another configuration example, and the configuration of one embodiment can be added with the configuration of another embodiment. Also, in a part of the respective configuration examples, another configuration can be added, deleted, or replaced.

The technique for creating the update draft of the preference type graph is not limited to only the above manner. For example, the customer group having the similar merchandise trend may be extracted by clustering to create an additional draft of a new preference type. In addition, with the extraction of the merchandise group likely to be purchased in the generated customer group on the basis of the demographic information of the client, after an arbitrary customer group and a merchandise group corresponding to the customer group have been extracted, a path additional draft between nodes of the preference type layer 120 and the merchandise attribute layer 130 which can describe the correspondence relationship between the customer group and the merchandise group may be created.

The system configuration of the present invention is not limited to that of FIG. 28. For example, a configuration in which only the store server 1100 and the customer analysis device 300 are connected to the network 1400 and a configuration in which the store server 1100 implements the preference type design and the type estimation for each individual are conceivable. The respective function units provided in the customer analysis device 300 does not always need to be installed in the same equipment, but the same functional block as that in FIG. 3 can be realized by providing those functional units across multiple pieces of equipment and communicating those functional units with each other.

Also, some or all of the above-described respective configurations, functions, processors, processing means may be realized, for example, as an integrated circuit, or other hardware. Also, the above respective configurations and functions may be realized by allowing the processor to interpret and execute programs for realizing the respective functions. That is, the respective configurations and functions may be realized by software. The information on the program, table, and file for realizing the respective functions can be stored in a storage device such as a memory, a hard disc, or an SSD (Solid State Drive), or a storage medium such as an IC card, an SD card, or a DVD.

### LIST OF REFERENCE SIGNS

300: customer analysis device, 301: initial design data, 310: design data, 320: preference type estimator, 330: evaluator, 331: merchandise matching degree analysis unit, 332: customer matching degree analysis unit, 333: division analysis unit, 334: integration analysis unit, 335: update instruction data, 336: update unit, 341: merchandise matching degree vector, 342: customer matching degree list, 343: concurrent selling rate matrix data, 350: update parameter, 360: display, 370: updater, 381: purchasing history data, 1000: customer analysis system.

1. A customer analysis system for analyzing a purchasing preference type of a customer for merchandises, comprising:
a purchasing history storage unit that stores purchasing history data describing a merchandise purchasing history of the customer,
a relationship matrix data storage unit that stores relationship matrix data describing a preference type correspondence relationship indicative of a correspondence relationship among the customer, the purchasing preference type of the customer, and the merchandises purchased by the customer having the purchasing preference type; and
an evaluator that evaluates the preference type correspondence relationship described in the relationship matrix data and outputs its evaluation result,
wherein the evaluator calculates a degree of matching indicative of how much a correspondence relationship between the purchasing preference type and the merchandise described in the relationship matrix data matches a correspondence relationship between the customer and the merchandise purchasing history described in the purchasing history data, thereby evaluating how accurately the preference type correspondence relationship describes the purchasing preference type of the customer.

2. The customer analysis system according to claim 1,
wherein the evaluator:
acquires, from the purchasing history data, one or more merchandise purchasing histories of the customers associated with the purchasing preference type on the preference type correspondence relationship;
tallies the acquired merchandise purchasing histories for each of the purchasing preference types to calculate a first purchasing trend vector obtained by quantifying a trend of purchasing the merchandises by one or more customers belonging to each of the purchasing preference type; and
compares the merchandise purchasing histories of the customers not associated with the purchasing preference types on the preference type correspondence relationship with the first purchasing trend vector to calculate the degree of matching.

3. The customer analysis system according to claim 2,
wherein the first purchasing trend vector is described by an element value indicative of whether or not the customer belonging to the purchasing preference types tends to purchase the merchandise;
the evaluator:
acquires the one or more merchandise purchasing histories not associated with the purchasing preference types on the preference type correspondence relationship from the purchasing history data, and tallies the acquired merchandise purchasing histories to calculate a purchasing reference value obtained by quantifying a trend of purchasing the merchandise by the one or more customers not belonging to each of the purchasing preference types; and
outputs the degree of matching indicating that the purchasing preference type tallied in calculating the first purchasing trend vector matches the customer if the element value is equal to or more than the purchasing reference value.

4. The customer analysis system according to claim 1,
wherein the evaluator:
acquires, from the purchasing history data, the one or more merchandise purchasing histories of the customers associated with the purchasing preference types on the preference type correspondence relationship;
tallies the acquired merchandise purchasing histories for each of the purchasing preference types, to calculate a second purchasing trend vector obtained by quantifying a trend of purchasing the merchandises by the customers belonging to the purchasing preference type for each customer, and to calculate an average vector of the second purchasing trend vectors of the respective customers; and
outputs the degree of matching indicating that the purchasing preference type does not match the customer for the customer belonging to the purchasing preference type when a distance between the second purchasing trend vector of the customer belonging to the purchase preference types and the average vector of the second purchasing trend vectors is equal to more than a predetermined distance.

5. The customer analysis system according to claim 4,
wherein the preference type correspondence relationship describes a correspondence relationship between a merchandise attribute type in which one or more of the merchandises are consolidated according to its/their attribute and the purchasing preference type, and
the evaluator:
acquires, from the purchasing history data, the one or more merchandise purchasing histories of the customers associated with the merchandise attribute type and associated with the purchasing preference type on the preference type correspondence relationship;
tallies the acquired merchandise purchasing histories for each of the purchasing preference types, to calculate a third purchasing trend vector obtained by quantifying a trend of purchasing the merchandises belonging to the merchandise attribute type by the customers belonging to the purchasing preference type for each of the customers, and to calculate an average vector of the third purchasing trend vectors of the respective customers; and
outputs the degree of matching indicating that the purchasing preference type does not match the customer for the customer belonging to the purchasing preference type when a distance between the third purchasing trend vector of the customer and the average vector of the third purchasing trend vector is equal to more than a predetermined distance.

6. The customer analysis system according to claim 1,
wherein the evaluator:
acquires, from the purchasing history data the one or more merchandise purchasing histories associated with the merchandise attribute type and associated with the purchasing preference type on the preference type correspondence relationship;
calculates a concurrent selling rate indicative of a probability of purchasing another of the merchandise when the customer belonging to the purchasing preference type purchases any merchandise on the basis of the acquired merchandise purchasing history; and
outputs division proposal data suggesting that the purchasing preference type in which the concurrent selling rate is equal to or less than a predetermined concurrent selling rate threshold is to be divided.

7. The customer analysis system according to claim 6,
wherein the evaluator updates the preference type correspondence relationship so that the two or more merchandises associated with the purchasing preference type on the preference type correspondence relationship, which are to be purchased by the same customer with the highest probability, are associated on the preference type correspondence relationship, and
wherein the evaluator calculates the concurrent selling rate on the basis of the updated preference type correspondence relationship.

8. The customer analysis system according to claim 1,
wherein the evaluator:
acquires, from the purchasing history data, one or more merchandise purchasing histories of the customers associated with a first purchasing preference type on the preference type correspondence relationship and one or more merchandise purchasing histories of the customers associated with a second purchasing preference type on the preference type correspondence relationship;
tallies the acquired merchandise purchasing histories for each of the purchasing preference types to calculate a fourth purchasing trend vector obtained by quantifying a trend of purchasing the merchandises by the customers belonging to the purchasing preference type for each of the purchasing preference types; and
outputs integration proposal data that suggests that the first purchasing preference type and the second purchasing preference type are to be integrated together when a distance between the fourth purchasing trend vector calculated for the first purchasing preference type and the fourth purchasing trend vector calculated for the second purchasing preference type is equal to less than a predetermined integration threshold.

9. The customer analysis system according to claim 1,
wherein the preference type correspondence relationship describes a correspondence relationship between a merchandise attribute type in which one or more of the merchandises are consolidated according to an attribute of the merchandises and the purchasing preference type,
wherein the customer analysis system further includes an updater that updates the preference type correspondence relationship to further increase the degree of matching on the basis of an evaluation result by the evaluator, and
wherein the updater updates the preference type correspondence relationship in the stated order of the correspondence relationship between the customers and the purchasing preference types, the correspondence relationship between the purchasing preference types and the merchandise attribute types, and the correspondence relationship between the merchandise attribute types and the merchandises.

10. The customer analysis system according to claim 1,
wherein the preference type correspondence relationship describes a purchasing preference type feature indicative of a feature of the purchasing preference type and a merchandise feature indicative of the feature of the merchandise,
wherein the customer analysis system includes an updater that updates the preference type correspondence relationship to further increase the degree of matching on the basis of the evaluation result by the evaluator, and
wherein the updater acquires the merchandise feature of the merchandise associated with the purchasing preference type on the pre-update correspondence relationship and sets the acquired merchandise feature as a post-update purchasing preference type when updating the correspondence relationship between the customers and the purchasing preference types.

11. The customer analysis system according to claim 1, further comprising an updater that updates the preference type correspondence relationship to further increase the degree of matching on the basis of the evaluation result by the evaluator,
wherein the updater calculates at least any one of the number of merchandises belonging to the post-update purchasing preference type and the number of customers belonging to the post-update purchasing preference type, and outputs its calculation result.

12. The customer analysis system according to claim 1, further comprising an updater that updates the preference type correspondence relationship to further increase the degree of matching on the basis of the evaluation result by the evaluator,
wherein the evaluator calculates the degree of matching of the updated preference type correspondence relationship at predetermined period intervals, and outputs its result.

13. The customer analysis system according to claim 1, further comprising:
a display that displays, on a screen, the preference type correspondence relationship and the evaluation result by the evaluator; and
an updater that receives an update instruction for instructing to update the preference type correspondence relationship which is displayed on the screen by the display and updates the preference type correspondence relationship according to the update instruction.

14. The customer analysis system according to claim 1, further comprising an updater that updates the preference type correspondence relationship to further increase the degree of matching on the basis of the evaluation result by the evaluator,
wherein the updater stores, in a storage device, update history data describing the update history in updating the preference type correspondence relationship.

15. The customer analysis system according to claim 1,
wherein the customer analysis system outputs a message describing information for promoting the customer belonging to the purchasing preference type to purchase the merchandise belonging to the purchasing preference type.
